(19) United States
(12) Patent Application Publication
(10) Pub. No.: US 2022/0295299 A1
(43) Pub. Date: Sep. 15, 2022

(54) METHOD AND DEVICE FOR TRANSMITTING/RECEIVING UPLINK SIGNAL IN WIRELESS COMMUNICATION SYSTEM

(71) Applicant: LG ELECTRONICS INC., Seoul (KR)

(72) Inventors: Jonghyun PARK, Seoul (KR); Jiwon KANG, Seoul (KR); Seongwon GO, Seoul (KR)

(21) Appl. No.: 17/634,933

(22) PCT Filed: Aug. 13, 2020
(86) PCT No.: PCT/KR2020/010793

§ 371 Date: Feb. 11, 2022

(30) Foreign Application Priority Data
Aug. 14, 2019 (KR) 10-2019-0099897

(51) Int. Cl. H04W 16/28; H04W 72/04; H04L 5/00

(52) U.S. Cl. CPC H04W 16/28; H04W 72/042; H04W 72/046; H04L 5/0051

(57) ABSTRACT

A method for transmitting an uplink signal by a terminal in a wireless communication system, according to an embodiment of the present specification, comprises the steps of: receiving configuration information related to transmission of an uplink signal; receiving downlink control information (DCI) related to a beam for transmission of the uplink signal; and transmitting the uplink signal on the basis of the DCI. The DCI includes a UL TCI field related to the UL TCI state. On the basis that the uplink signal is a physical uplink shared channel (PUSCH) and the UL TCI field indicates a specific state, a beam for transmission of the PUSCH is determined on the basis of an SRI field in the DCI.

### TECHNICAL FIELD

The disclosure relates to a method and device for transmitting and receiving uplink signals in a wireless communication system.

### BACKGROUND ART

Mobile communication systems have been developed to guarantee user activity while providing voice services. Mobile communication systems are expanding their services from voice only to data. Current soaring data traffic is depleting resources and users' demand for higher-data rate services is leading to the need for more advanced mobile communication systems.

Next-generation mobile communication systems are required to meet, e.g., handling of explosively increasing data traffic, significant increase in per-user transmission rate, working with a great number of connecting devices, and support for very low end-to-end latency and high-energy efficiency. To that end, various research efforts are underway for various technologies, such as dual connectivity, massive multiple input multiple output (MIMO), in-band full duplex, non-orthogonal multiple access (NOMA), super wideband support, and device networking.

### DISCLOSURE

### Technical Problem

The disclosure proposes a method of transmitting an uplink signal using an uplink transmission configuration indicator state (UL TCI state).

Specifically, the disclosure proposes a method for utilizing an UL TCI state depending on the type (e.g., a PUSCH, a PRACH, etc.) of an uplink signal.

The technical objects of the present disclosure are not limited to the aforementioned technical objects, and other technical objects, which are not mentioned above, will be apparently appreciated by a person having ordinary skill in the art from the following description.

### Technical Solution

A method of transmitting, by a UE, an uplink signal in a wireless communication system according to an embodiment of the disclosure includes receiving configuration information related to the transmission of an uplink signal, receiving downlink control information (DCI) related to a beam for the transmission of the uplink signal, and transmitting the uplink signal based on the DCI.

The configuration information is related to an uplink transmission configuration indicator state (UL TCI state), and the UL TCI state includes a spatial relation RS related to the beam for the transmission of the uplink signal. The DCI includes an UL TCI field related to the UL TCI state.

A beam for a transmission of a physical uplink shared channel (PUSCH) is determined based on an SRI field of the DCI, based on the uplink signal being the PUSCH and the UL TCI field indicating a specific state.

The UL TCI state may include at least one panel ID related to the transmission of the uplink signal.

The at least one panel related to the transmission of the PUSCH may be determined as a panel related to the transmission of a sounding reference signal (SRS) based on the SRI field.

The at least one panel related to the transmission of the PUSCH may be determined as a preconfigured panel among a plurality of panels of the UE.

The beam for the transmission of the PUSCH may be determined based on beam information related to the most recent transmission of the SRS, based on an SRS resource within an SRS resource set configured in the UE being one.

The usage of the SRS resource set may be based on a codebook based UL or a non-codebook based UL.

The beam for the transmission of the PUSCH may be determined based on the spatial relation RS of the UL TCI state, based on the uplink signal being the PUSCH and the UL TCI field indicating the UL TCI state.

The spatial relation RS may be related to an SRS resource within a specific SRS resource set. The usage of the specific SRS resource set may be based on a codebook based UL or a non-codebook based UL.

The configuration information may include information for a pool consisting of a plurality of UL TCI states.

A UE transmitting an uplink signal in a wireless communication system according to another embodiment of the disclosure includes one or more transceivers, one or more processors controlling the one or more transceivers, and one or more memories capable of being operately connected to the one or more processors and storing instructions performing operations when a transmission of an uplink signal is executed by the one or more processors.

The operations include receiving configuration information related to the transmission of an uplink signal, receiving downlink control information (DCI) related to a beam for the transmission of the uplink signal, and transmitting the uplink signal based on the DCI.

The configuration information is related to an uplink transmission configuration indicator state (UL TCI state), and the UL TCI state includes a spatial relation RS related to the beam for the transmission of the uplink signal. The DCI includes an UL TCI field related to the UL TCI state.

A beam for a transmission of a physical uplink shared channel (PUSCH) may be determined based on an SRI field of the DCI, based on the uplink signal being the PUSCH and the UL TCI field indicating a specific state.

A device according to still another embodiment of the disclosure includes one or more memories and one or more processors functionally connected to the one or more memories.

The one or more processors are configured to enable the device to receive configuration information related to the transmission of an uplink signal, receive downlink control information (DCI) related to a beam for the transmission of the uplink signal, and transmit the uplink signal based on the DCI.

The configuration information is related to an uplink transmission configuration indicator state (UL TCI state), and the UL TCI state includes a spatial relation RS related to the beam for the transmission of the uplink signal. The DCI includes an UL TCI field related to the UL TCI state.

A beam for a transmission of a physical uplink shared channel (PUSCH) may be determined based on an SRI field of the DCI, based on the uplink signal being the PUSCH and the UL TCI field indicating a specific state.

One or more non-transitory computer-readable media according to still another embodiment of the disclosure store one or more instructions.

One or more commands executable by one or more processors are configured to enable a UE to receive configuration information related to the transmission of an uplink signal, receive downlink control information (DCI) related to a beam for the transmission of the uplink signal, and transmit the uplink signal based on the DCI.

The configuration information is related to an uplink transmission configuration indicator state (UL TCI state), and the UL TCI state includes a spatial relation RS related to the beam for the transmission of the uplink signal. The DCI includes an UL TCI field related to the UL TCI state.

A beam for a transmission of a physical uplink shared channel (PUSCH) may be determined based on an SRI field of the DCI, based on the uplink signal being the PUSCH and the UL TCI field indicating a specific state.

A method of receiving, by a base station, an uplink signal in a wireless communication system according to still another embodiment of the disclosure includes transmitting configuration information related to the transmission of an uplink signal, transmitting downlink control information (DCI) related to a beam for the transmission of the uplink signal, and receiving the uplink signal based on the DCI.

The configuration information is related to an uplink transmission configuration indicator state (UL TCI state), and the UL TCI state includes a spatial relation RS related to the beam for the transmission of the uplink signal. The DCI includes an UL TCI field related to the UL TCI state.

A beam for a transmission of a physical uplink shared channel (PUSCH) may be determined based on an SRI field of the DCI, based on the uplink signal being the PUSCH and the UL TCI field indicating a specific state.

A base station receiving an uplink signal in a wireless communication system according to still another embodiment of the disclosure includes one or more transceivers, one or more processors controlling the one or more transceivers, and one or more memories capable of being operately connected to the one or more processors and storing instructions performing operations when the reception of the uplink signal is executed by the one or more processors.

The operations include transmitting configuration information related to the transmission of an uplink signal, transmitting downlink control information (DCI) related to a beam for the transmission of the uplink signal, and receiving the uplink signal based on the DCI.

The configuration information is related to an uplink transmission configuration indicator state (UL TCI state), and the UL TCI state includes a spatial relation RS related to the beam for the transmission of the uplink signal. The DCI includes an UL TCI field related to the UL TCI state.

A beam for a transmission of a physical uplink shared channel (PUSCH) may be determined based on an SRI field of the DCI, based on the uplink signal being the PUSCH and the UL TCI field indicating a specific state.

### Advantageous Effects

According to an embodiment of the disclosure, a beam for the transmission of a physical uplink shared channel (PUSCH) can be determined based on an SRI field of DCI, based on an uplink signal being the PUSCH and an UL TCI field of the DCI indicating a specific state.

Accordingly, although an uplink transmission configuration indicator state (UL TCI state) is configured for the transmission of an uplink signal, a beam for the transmission of a PUSCH can be determined without colliding against the existing beam indication operation.

According to an embodiment of the disclosure, at least one panel ID related to the transmission of a PUSCH can be determined as a panel related to the transmission of a sounding reference signal (SRS) based on an SRI field. Alternatively, at least one panel ID related to the transmission of a PUSCH can be determined as a preconfigured panel among a plurality of panels of a UE. That is, a panel based on the SRI field or the preconfigured panel is used for the transmission of the PUSCH based on an UL TCI field indicating a specific state (e.g., a default state). The transmission of an uplink signal based on a default panel (e.g., a panel based on an SRI field or a preconfigured panel) can be indicated through (a specific state of) an UL TCI field in a specific situation/environment in which panel selection (or panel switching) is not smoothly supported.

Effects which may be obtained by the present disclosure are not limited to the aforementioned effects, and other technical effects not described above may be evidently understood by a person having ordinary skill in the art to which the present disclosure pertains from the following description.

### DESCRIPTION OF DRAWINGS

The accompanying drawings, which are included to provide a further understanding of the present disclosure and constitute a part of the detailed description, illustrate embodiments of the present disclosure and together with the description serve to explain the principle of the present disclosure.

FIG. 1 is a diagram illustrating an example of an overall system structure of NR to which a method proposed in the present disclosure is applicable.

FIG. 2 illustrates a relationship between an uplink frame and a downlink frame in a wireless communication system to which a method proposed by the present disclosure is applicable.

FIG. 3 illustrates an example of a frame structure in an NR system.

FIG. 4 illustrates an example of a resource grid supported by a wireless communication system to which a method proposed in the present disclosure is applicable.

FIG. 5 illustrates examples of a resource grid for each antenna port and numerology to which a method proposed in the present disclosure is applicable.

FIG. 6 illustrates physical channels and general signal transmission used in a 3GPP system.

FIG. 7 illustrates an example of beamforming using SSB and CSI-RS.

FIG. 8 illustrates an example of a UL BM procedure using an SRS.

FIG. 9 is a flowchart showing an example of a UL BM procedure using the SRS.

FIG. 10 is a flowchart showing an example of an uplink transmission/reception operation to which a method proposed in the present disclosure may be applied.

FIG. 11 and FIG. 12 illustrate an example of multi-panel based on an RF switch applied to the disclosure.

FIG. 13 illustrates an example of signaling between a UE/base station to which a method proposed in the disclosure may be applied.

FIG. 14 is a flowchart for describing a method of transmitting, by a UE, an uplink signal in a wireless communication system according to an embodiment of the disclosure.

FIG. 15 is a flowchart for describing a method of receiving, by a base station, an uplink signal in a wireless communication system according to another embodiment of the disclosure.

FIG. 16 illustrates a communication system 1 applied to the present disclosure.

FIG. 17 illustrates wireless devices applicable to the present disclosure.

FIG. 18 illustrates a signal process circuit for a transmission signal.

FIG. 19 illustrates another example of a wireless device applied to the present disclosure.

FIG. 20 illustrates a hand-held device applied to the present disclosure.

### MODE FOR DISCLOSURE

Hereinafter, preferred embodiments of the disclosure are described in detail with reference to the accompanying drawings. The following detailed description taken in conjunction with the accompanying drawings is intended for describing example embodiments of the disclosure, but not for representing a sole embodiment of the disclosure. The detailed description below includes specific details to convey a thorough understanding of the disclosure. However, it will be easily appreciated by one of ordinary skill in the art that embodiments of the disclosure may be practiced even without such details.

In some cases, to avoid ambiguity in concept, known structures or devices may be omitted or be shown in block diagrams while focusing on core features of each structure and device.

Hereinafter, downlink (DL) means communication from a base station to a terminal and uplink (UL) means communication from the terminal to the base station. In the downlink, a transmitter may be part of the base station, and a receiver may be part of the terminal. In the uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology such as universal terrestrial radio access (UTRA) or CDMA2000. The TDMA may be implemented by radio technology such as global system for mobile communications (GSM)/general packet radio service (GPRS)/enhanced data rates for GSM evolution (EDGE). The OFDMA may be implemented as radio technology such as IEEE 802.11 (Wi-Fi), IEEE 802.16 (WiMAX), IEEE 802-20, E-UTRA (evolved UTRA), and the like. The UTRA is a part of a universal mobile telecommunication system (UMTS). 3rd generation partnership project (3GPP) long term evolution (LTE), as a part of an evolved UMTS (E-UMTS) using E-UTRA, adopts the OFDMA in the downlink and the SC-FDMA in the uplink. LTE-A (advanced) is the evolution of 3GPP LTE.

For clarity of description, the present disclosure is described based on the 3GPP communication system (e.g., LTE-A or NR), but the technical spirit of the present disclosure are not limited thereto. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a standard document detail number. The LTE/NR may be collectively referred to as the 3GPP system. Matters disclosed in a standard document published before the present disclosure may refer to a background art, terms, abbreviations, etc., used for describing the present disclosure. For example, the following documents may be referenced.

3GPP LTE
36.211: Physical channels and modulation
36.212: Multiplexing and channel coding
36.213: Physical layer procedures
36.300: Overall description
36.331: Radio Resource Control (RRC)

3GPP NR
38.211: Physical channels and modulation
38.212: Multiplexing and channel coding
38.213: Physical layer procedures for control
38.214: Physical layer procedures for data
38.300: NR and NG-RAN Overall Description
36.331: Radio Resource Control (RRC) protocol specification

As more and more communication devices require larger communication capacity, there is a need for improved mobile broadband communication compared to the existing radio access technology (RAT). Further, massive machine type communications (MTCs), which provide various services anytime and anywhere by connecting many devices and objects, are one of the major issues to be considered in the next generation communication. In addition, a communication system design considering a service/UE sensitive to reliability and latency is being discussed. As such, the introduction of next-generation radio access technology considering enhanced mobile broadband communication (eMBB), massive MTC (mMTC), ultra-reliable and low latency communication (URLLC) is discussed, and in the present disclosure, the technology is called NR for convenience. The NR is an expression representing an example of 5G radio access technology (RAT).

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver can drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

In a New RAT system including NR uses an OFDM transmission scheme or a similar transmission scheme thereto. The new RAT system may follow OFDM parameters different from OFDM parameters of LTE. Alternatively, the new RAT system may follow numerology of conventional LTE/LTE-A as it is or have a larger system bandwidth (e.g., 100 MHz). Alternatively, one cell may support a plurality of numerologies. In other words, UEs that operate with different numerologies may coexist in one cell.

The numerology corresponds to one subcarrier spacing in a frequency domain. By scaling a reference subcarrier spacing by an integer N, different numerologies can be defined.

### Definition of Terms

eLTE eNB: The eLTE eNB is the evolution of eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network defined by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used at an NG2 reference point between new RAN and NGC.

NG-U: A user plane interface used at an NG3 reference point between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: An end point of NG-U interface.

Overview of System

FIG. 1 illustrates an example overall NR system structure to which a method as proposed in the disclosure may apply.

Referring to FIG. 1, an NG-RAN is constituted of gNBs to provide a control plane (RRC) protocol end for user equipment (UE) and NG-RA user plane (new AS sublayer/PDCP/RLC/MAC/PHY).

The gNBs are mutually connected via an Xn interface.

The gNBs are connected to the NGC via the NG interface.

More specifically, the gNB connects to the access and mobility management function (AMF) via the N2 interface and connects to the user plane function (UPF) via the N3 interface.

New RAT (NR) Numerology and Frame Structure

In the NR system, a number of numerologies may be supported. Here, the numerology may be defined by the subcarrier spacing and cyclic prefix (CP) overhead. At this time, multiple subcarrier spacings may be derived by scaling the basic subcarrier spacing by integer N (or, μ). Further, although it is assumed that a very low subcarrier spacing is not used at a very high carrier frequency, the numerology used may be selected independently from the frequency band.

Further, in the NR system, various frame structures according to multiple numerologies may be supported.

Hereinafter, an orthogonal frequency division multiplexing (OFDM) numerology and frame structure that may be considered in the NR system is described.

The multiple OFDM numerologies supported in the NR system may be defined as shown in Table 1.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

NR supports multiple numerologies (or subcarrier spacings (SCS)) for supporting various 5G services. For example, if SCS is 15 kHz, NR supports a wide area in typical cellular bands. If SCS is 30 kHz/60 kHz, NR supports a dense urban, lower latency and a wider carrier bandwidth. If SCS is 60 kHz or higher, NR supports a bandwidth greater than 24.25 GHz in order to overcome phase noise.

An NR frequency band is defined as a frequency range of two types FR1 and FR2. The FR1 and the FR2 may be configured as in Table 1 below. Furthermore, the FR2 may mean a millimeter wave (mmW).

TABLE 2

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

With regard to the frame structure in the NR system, the size of various fields in the time domain is expressed as a multiple of time unit of Tₛ=1/(Δfₘₐₓ·N_{f}), where Δfₘₐₓ=480·10³, and N_{f}=4096. Downlink and uplink transmissions is constituted of a radio frame with a period of T_{f}=(ΔfₘₐₓN_{f}/100)·Tₛ=10 ms. Here, the radio frame is constituted of 10 subframes each of which has a period of T_{sf}=(Δfₘₐₓ N_{f}/1000)·Tₛ=1 ms. In this case, one set of frames for uplink and one set of frames for downlink may exist.

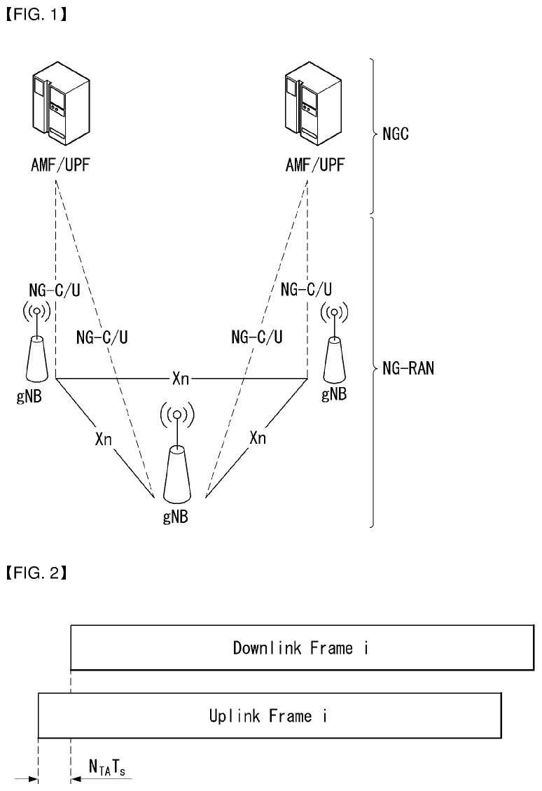

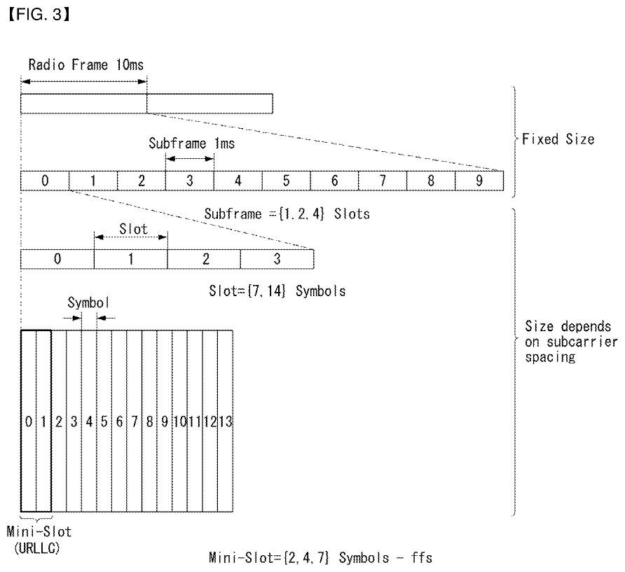

FIG. 2 illustrates a relationship between an uplink frame and downlink frame in a wireless communication system to which a method described in the present disclosure is applicable.

As illustrated in FIG. 2, uplink frame number i for transmission from the user equipment (UE) should begin T_{TA}=N_{TA}Tₛ earlier than the start of the downlink frame by the UE.

For numerology μ, slots are numbered in ascending order of nₛ^{μ}ϵ{0, . . . , N_{subframe}^{slots,μ}−1} in the subframe and in ascending order of n_{s,f}^{μ}ϵ{0, . . . , N_{frame}^{slots,μ}−1} in the radio frame. One slot includes consecutive OFDM symbols of N_{symb}^{μ}, and N_{symb}^{μ} is determined according to the used numerology and slot configuration. In the subframe, the start of slot nₛ^{μ} is temporally aligned with the start of nₛ^{μ}N_{symb}^{μ}.

Not all UEs are able to transmit and receive at the same time, and this means that not all OFDM symbols in a downlink slot or an uplink slot are available to be used.

Table 3 represents the number N_{symb}^{slot} of OFDM symbols per slot, the number Nₛₗₒₜ^{frame,μ} slot of slots per radio frame, and the number Nₛₗₒₜ^{subframe,μ} slot of slots per subframe in a normal CP. Table 4 represents the number of OFDM symbols per slot, the number of slots per radio frame, and the number of slots per subframe in an extended CP.

TABLE 3

| μ | N_{symb}^{slot} | Nₛₗₒₜ^{frame, μ} | Nₛₗₒₜ^{subrame, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame,μ} | Nₛₗₒₜ^{subframe,μ} |
|---|---|---|---|
| 2 | 12 | 40 | 4 |

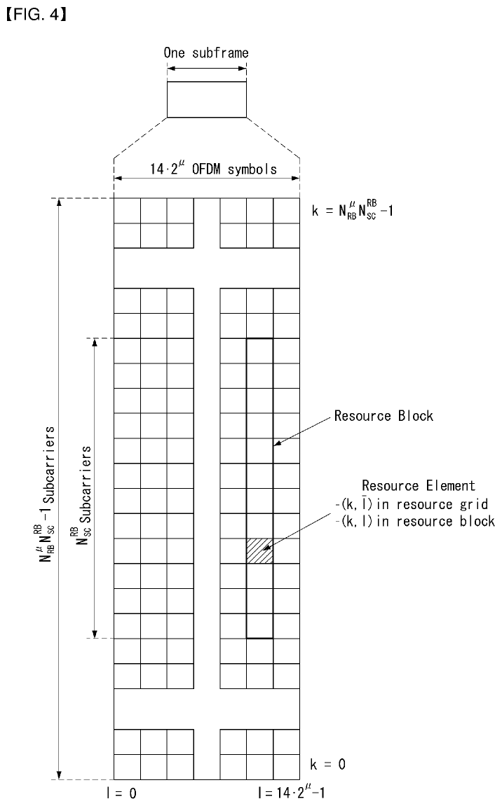

FIG. 3 illustrates an example of a frame structure in a NR system. FIG. 3 is merely for convenience of explanation and does not limit the scope of the present disclosure.

In Table 4, in case of μ=2, i.e., as an example in which a subcarrier spacing (SCS) is 60 kHz, one subframe (or frame) may include four slots with reference to Table 3, and one subframe={1, 2, 4} slots shown in FIG. 3, for example, the number of slot(s) that may be included in one subframe may be defined as in Table 3.

Further, a mini-slot may consist of 2, 4, or 7 symbols, or may consist of more symbols or less symbols.

In regard to physical resources in the NR system, an antenna port, a resource grid, a resource element, a resource block, a carrier part, etc. may be considered.

Hereinafter, the above physical resources that can be considered in the NR system are described in more detail.

First, in regard to an antenna port, the antenna port is defined so that a channel over which a symbol on an antenna port is conveyed can be inferred from a channel over which another symbol on the same antenna port is conveyed. When large-scale properties of a channel over which a symbol on one antenna port is conveyed can be inferred from a channel over which a symbol on another antenna port is conveyed, the two antenna ports may be regarded as being in a quasi co-located or quasi co-location (QC/QCL) relation. Here, the large-scale properties may include at least one of delay spread, Doppler spread, frequency shift, average received power, and received timing.

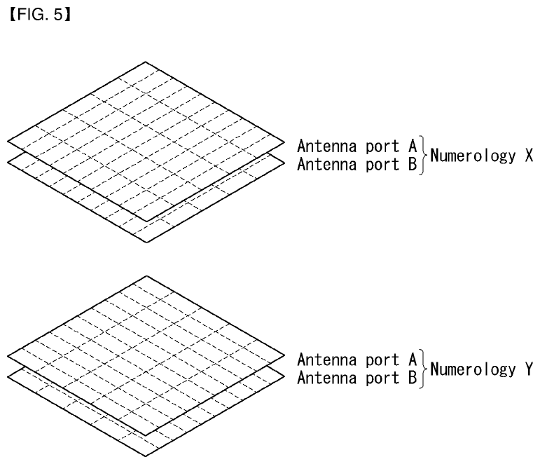

FIG. 4 illustrates an example of a resource grid supported in a wireless communication system to which a method proposed in the present disclosure is applicable.

Referring to FIG. 4, a resource grid consists of N_{RB}^{μ}N_{sc}^{RB} subcarriers on a frequency domain, each subframe consisting of 14.2μ OFDM symbols, but the present disclosure is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols, where N_{RB}^{μ}≤N_{RB}^{max,μ}. N_{RB}^{max,μ} denotes a maximum transmission bandwidth and may change not only between numerologies but also between uplink and downlink.

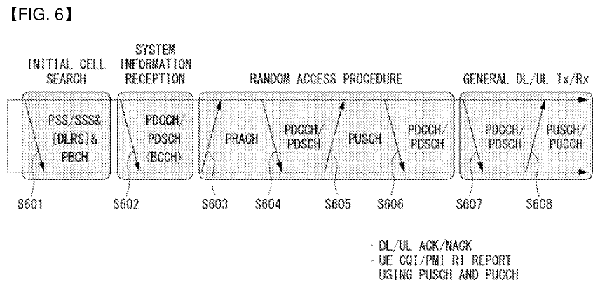

In this case, as illustrated in FIG. 5, one resource grid may be configured per numerology μ and antenna port p.

FIG. 5 illustrates examples of a resource grid per antenna port and numerology to which a method proposed in the present disclosure is applicable.

Each element of the resource grid for the numerology μ and the antenna port p is called a resource element and is uniquely identified by an index pair (k, l̅), where k=0, . . . , N_{RB}^{μ}N_{sc}^{RB}−1 is an index on a frequency domain, and l̅=0, . . . , 2^{μ}N_{symb}^{(μ)}−1 refers to a location of a symbol in a subframe. The index pair (k, l̅) is used to refer to a resource element in a slot, where l=0, . . . , N_{symb}^{μ}−1.

The resource element (k, l̅) for the numerology μ and the antenna port p corresponds to a complex value a_{k,l̅}^{(p,μ)}. When there is no risk for confusion or when a specific antenna port or numerology is not specified, the indexes p and μ may be dropped, and as a result, the complex value may be a_{k,l̅}^{(p)} or a_{k,l̅}.

Further, a physical resource block is defined as N_{sc}^{RB}=12 consecutive subcarriers in the frequency domain.

Point A serves as a common reference point of a resource block grid and may be obtained as follows.
offsetToPointA for PCell downlink represents a frequency offset between the point A and a lowest subcarrier of a lowest resource block that overlaps a SS/PBCH block used by the UE for initial cell selection, and is expressed in units of resource blocks assuming 15 kHz subcarrier spacing for FR1 and 60 kHz subcarrier spacing for FR2.
absoluteFrequencyPointA represents frequency-location of the point A expressed as in absolute radio-frequency channel number (ARFCN).

The common resource blocks are numbered from 0 and upwards in the frequency domain for subcarrier spacing configuration μ.

The center of subcarrier 0 of common resource block 0 for the subcarrier spacing configuration μ coincides with ‘point A’. A common resource block number n_{CRB}^{μ} in the frequency domain and resource elements (k, l) for the subcarrier spacing configuration μ may be given by the following Equation 1.

$${n}_{C R B}^{μ} = ⌊ \frac{k}{{N}_{s c}^{R B}} ⌋ \qquad [ Equation 1 ]$$

Here, k may be defined relative to the point A so that k=0 corresponds to a subcarrier centered around the point A. Physical resource blocks are defined within a bandwidth part (BWP) and are numbered from 0 to N_{BWP,i}^{size}−1, where i is No. of the BWP. A relation between the physical resource block n_{PRB} in BWP i and the common resource block n_{CRB} may be given by the following Equation 2.

n_{CRB}=n_{PRB}+N_{BWP,i}^{start} [Equation 2]

Here, N_{BWP,i}^{start} may be the common resource block where the BWP starts relative to the common resource block 0.

Physical Channel and General Signal Transmission

FIG. 6 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S601). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S602).

Meanwhile, when there is no radio resource first accessing the eNB or for signal transmission, the UE may perform a Random Access Procedure (RACH) to the eNB (S603 to S606). To this end, the UE may transmit a specific sequence to a preamble through a Physical Random Access Channel (PRACH) (S603 and S605) and receive a response message (Random Access Response (RAR) message) for the preamble through the PDCCH and a corresponding PDSCH. In the case of a contention based RACH, a Contention Resolution Procedure may be additionally performed (S606).

The UE that performs the above procedure may then perform PDCCH/PDSCH reception (S607) and Physical Uplink Shared Channel (PUSCH)/Physical Uplink Control Channel (PUCCH) transmission (S608) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

Meanwhile, the control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

Beam Management (BM)

A BM procedure as layer 1 (L1)/layer 2 (L2) procedures for acquiring and maintaining a set of base station (e.g., gNB, TRP, etc.) and/or terminal (e.g., UE) beams which may be used for downlink (DL) and uplink (UL) transmission/reception may include the following procedures and terms.
Beam measurement: Operation of measuring characteristics of a beam forming signal received by the eNB or UE.
Beam determination: Operation of selecting a transmit (Tx) beam/receive (Rx) beam of the eNB or UE by the eNB or UE.
Beam sweeping: Operation of covering a spatial region using the transmit and/or receive beam for a time interval by a predetermined scheme.
Beam report: Operation in which the UE reports information of a beamformed signal based on beam measurement.

The BM procedure may be divided into (1) a DL BM procedure using a synchronization signal (SS)/physical broadcast channel (PBCH) Block or CSI-RS and (2) a UL BM procedure using a sounding reference signal (SRS). Further, each BM procedure may include Tx beam sweeping for determining the Tx beam and Rx beam sweeping for determining the Rx beam.

Downlink Beam Management (DL BM)

The DL BM procedure may include (1) transmission of beamformed DL reference signals (RSs) (e.g., CIS-RS or SS Block (SSB)) of the eNB and (2) beam reporting of the UE.

Here, the beam reporting a preferred DL RS identifier (ID)(s) and L1-Reference Signal Received Power (RSRP).

The DL RS ID may be an SSB Resource Indicator (SSBRI) or a CSI-RS Resource Indicator (CRI).

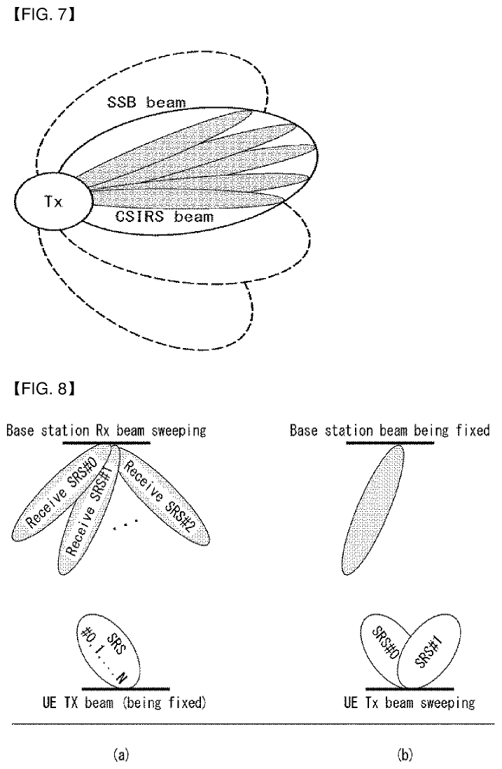

FIG. 7 illustrates an example of beamforming using a SSB and a CSI-RS.

As illustrated in FIG. 7, a SSB beam and a CSI-RS beam may be used for beam measurement. A measurement metric is L1-RSRP per resource/block. The SSB may be used for coarse beam measurement, and the CSI-RS may be used for fine beam measurement. The SSB may be used for both Tx beam sweeping and Rx beam sweeping. The Rx beam sweeping using the SSB may be performed while the UE changes Rx beam for the same SSBRI across multiple SSB bursts. One SS burst includes one or more SSBs, and one SS burst set includes one or more SSB bursts.

DL BM Related Beam Indication

A UE may be RRC-configured with a list of up to M candidate transmission configuration indication (TCI) states at least for the purpose of quasi co-location (QCL) indication, where M may be 64.

Each TCI state may be configured with one RS set. Each ID of DL RS at least for the purpose of spatial QCL (QCL Type D) in an RS set may refer to one of DL RS types such as SSB, P-CSI RS, SP-CSI RS, A-CSI RS, etc.

Initialization/update of the ID of DL RS(s) in the RS set used at least for the purpose of spatial QCL may be performed at least via explicit signaling.

Table 5 represents an example of TCI-State IE.

The TCI-State IE associates one or two DL reference signals (RSs) with corresponding quasi co-location (QCL) types.

TABLE 5
-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

In Table 5, bwp-ld parameter represents a DL BWP where the RS is located, cell parameter represents a carrier where the RS is located, and reference signal parameter represents reference antenna port(s) which is a source of quasi co-location for corresponding target antenna port(s) or a reference signal including the one. The target antenna port(s) may be CSI-RS, PDCCH DMRS, or PDSCH DMRS. As an example, in order to indicate QCL reference RS information on NZP CSI-RS, the corresponding TCI state ID may be indicated to NZP CSI-RS resource configuration information. As another example, in order to indicate QCL reference information on PDCCH DMRS antenna port(s), the TCI state ID may be indicated to each CORESET configuration. As another example, in order to indicate QCL reference information on PDSCH DMRS antenna port(s), the TCI state ID may be indicated via DCI.

Quasi-Co Location (QCL)

The antenna port is defined so that a channel over which a symbol on an antenna port is conveyed can be inferred from a channel over which another symbol on the same antenna port is conveyed. When properties of a channel over which a symbol on one antenna port is conveyed can be inferred from a channel over which a symbol on another antenna port is conveyed, the two antenna ports may be considered as being in a quasi co-located or quasi co-location (QC/QCL) relationship.

The channel properties include one or more of delay spread, Doppler spread, frequency/Doppler shift, average received power, received timing/average delay, and spatial RX parameter. The spatial Rx parameter means a spatial (reception) channel property parameter such as an angle of arrival.

The UE may be configured with a list of up to M TCI-State configurations within the higher layer parameter PDSCH-Config to decode PDSCH according to a detected PDCCH with DCI intended for the corresponding UE and a given serving cell, where M depends on UE capability.

Each TCI-State contains parameters for configuring a quasi co-location relationship between one or two DL reference signals and the DM-RS ports of the PDSCH.

The quasi co-location relationship is configured by the higher layer parameter qcl-Type1 for the first DL RS and qcl-Type2 for the second DL RS (if configured). For the case of two DL RSs, the QCL types are not be the same, regardless of whether the references are to the same DL RS or different DL RSs.

The quasi co-location types corresponding to each DL RS are given by the higher layer parameter qcl-Type of QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, if a target antenna port is a specific NZP CSI-RS, the corresponding NZP CSI-RS antenna ports may be indicated/configured to be QCLed with a specific TRS in terms of QCL-TypeA and with a specific SSB in terms of QCL-TypeD. The UE receiving the indication/configuration may receive the corresponding NZP CSI-RS using the Doppler or delay value measured in the QCL-TypeA TRS and apply the Rx beam used for QCL-TypeD SSB reception to the reception of the corresponding NZP CSI-RS reception.

The UE may receive an activation command by MAC CE signaling used to map up to eight TCI states to the codepoint of the DCI field ‘Transmission Configuration Indication’.

UL BM Procedure

UL BM may be configured such that beam reciprocity (or beam correspondence) between Tx beam and Rx beam is established or not established depending on the UE implementation. If the beam reciprocity between Tx beam and Rx beam is established in both a base station and a UE, a UL beam pair may be adjusted via a DL beam pair. However, if the beam reciprocity between Tx beam and Rx beam is not established in any one of the base station and the UE, a process for determining the UL beam pair is necessary separately from determining the DL beam pair.

Even when both the base station and the UE maintain the beam correspondence, the base station may use a UL BM procedure for determining the DL Tx beam even if the UE does not request a report of a (preferred) beam.

The UM BM may be performed via beamformed UL SRS transmission, and whether to apply UL BM of a SRS resource set is configured by the (higher layer parameter) usage. If the usage is set to ‘BeamManagement (BM)’, only one SRS resource may be transmitted to each of a plurality of SRS resource sets in a given time instant.

The UE may be configured with one or more sounding reference symbol (SRS) resource sets configured by (higher layer parameter) SRS-ResourceSet (via higher layer signaling, RRC signaling, etc.). For each SRS resource set, the UE may be configured with K≥1 SRS resources (higher later parameter SRS-resource), where K is a natural number, and a maximum value of K is indicated by SRS_capability.

In the same manner as the DL BM, the UL BM procedure may be divided into a UE's Tx beam sweeping and a base station's Rx beam sweeping.

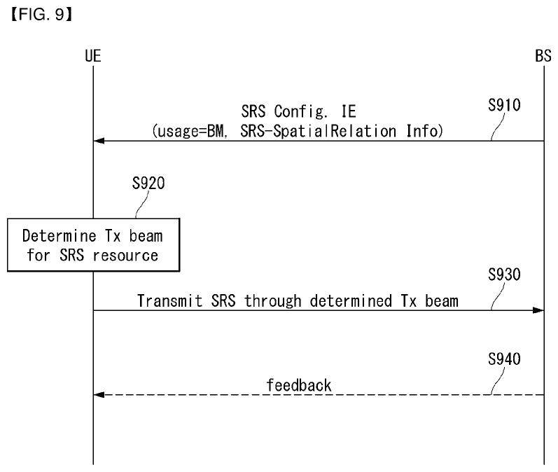

FIG. 8 illustrates an example of an UL BM procedure using a SRS.

More specifically, (a) of FIG. 8 illustrates an Rx beam determination procedure of a base station, and (a) of FIG. 8 illustrates a Tx beam sweeping procedure of a UE.

FIG. 9 is a flow chart illustrating an example of an UL BM procedure using a SRS.
The UE receives, from the base station, RRC signaling (e.g., SRS-Config IE) including (higher layer parameter) usage parameter set to ‘beam management’ in S910.

Table 6 represents an example of SRS-Config information element (IE), and the SRS-Config IE is used for SRS transmission configuration. The SRS-Config IE contains a list of SRS-Resources and a list of SRS-Resource sets. Each SRS resource set means a set of SRS resources.

The network may trigger transmission of the SRS resource set using configured aperiodicSRS-ResourceTrigger (L1 DCI).

TABLE 6
-- ASN1START
-- TAG-MAC-CELL-GROUP-CONFIG-START

| | |
|---|---|
| SRS-Config ::= | SEQUENCE { |

| srs-ResourceSetToReleaseList | SEQUENCE (SIZE(1..maxNrofSRS- | |
|---|---|---|
| ResourceSets)) OF SRS-ResourceSetId | OPTIONAL, | -- Need N |
| srs-ResourceSetToAddModList | SEQUENCE (SIZE(1..maxNrofSRS- | |
| ResourceSets)) OF SRS-ResourceSet | OPTIONAL, | -- Need N |
| srs-ResourceToReleaseList | SEQUENCE (SIZE(1..maxNrofSRS- | |
| Resources)) OF SRS-ResourceId | OPTIONAL, | -- Need N |
| srs-ResourceToAddModList | SEQUENCE (SIZE(1..maxNrofSRS- | |
| Resources)) OF SRS-Resource | OPTIONAL, | -- Need N |

| | |
|---|---|
| tpc-Accumulation | ENUMERATED {disabled} |

...
}

| | |
|---|---|
| SRS-ResourceSet ::= | SEQUENCE { |

| | |
|---|---|
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |

| | |
|---|---|
| resourceType | CHOICE { |

| | |
|---|---|
| aperiodic | SEQUENCE { |
| aperiodicSRS-ResourceTrigger | INTEGER (1..maxNrofSRS- |

TriggerStates-1),

| | |
|---|---|
| csi-RS | NZP-CSI-RS-ResourceId |
| slotOffset | INTEGER (1..32) |

```
      ...
    },
```

| | |
|---|---|
| semi-persistent | SEQUENCE { |
| associatedCSI-RS | NZP-CSI-RS-ResourceId |

```
      ...
    },
```

| | |
|---|---|
| periodic | SEQUENCE { |
| associatedCSI-RS | NZP-CSI-RS-ResourceId |

```
      ...
    }
  },
```

| | |
|---|---|
| usage | ENUMERATED {beamManagement, |

codebook, nonCodebook, antennaSwitching},

| | |
|---|---|
| alpha | Alpha |
| p0 | INTEGER (−202..24) |
| pathlossReferenceRS | CHOICE { |
| ssb-Index | SSB-Index, |
| csi-RS-Index | NZP-CSI-RS-ResourceId |

| | |
|---|---|
| SRS-SpatialRelationInfo ::= | SEQUENCE { |
| servingCellId | ServCellIndex |
| referenceSignal | CHOICE { |
| ssb-Index | SSB-Index, |
| csi-RS-Index | NZP-CSI-RS-ResourceId, |

| | |
|---|---|
| srs | SEQUENCE { |
| resourceId | SRS-ResourceId, |
| uplinkBWP | BWP-Id |

```
    }
  }
}
```

| | |
|---|---|
| SRS-ResourceId ::= | INTEGER (0..maxNrofSRS-Resources-1) |

In Table 6, usage refers to a higher layer parameter to indicate whether the SRS resource set is used for beam management or is used for codebook based or non-codebook based transmission. The usage parameter corresponds to L1 parameter ‘SRS-SetUse’. ‘spatialRelationInfo’ is a parameter representing a configuration of spatial relation between a reference RS and a target SRS. The reference RS may be SSB, CSI-RS, or SRS which corresponds to L1 parameter ‘SRS-SpatialRelationInfo’. The usage is configured per SRS resource set.
The UE determines the Tx beam for the SRS resource to be transmitted based on SRS-SpatialRelation Info contained in the SRS-Config IE in S920. The SRS-SpatialRelation Info is configured per SRS resource and indicates whether to apply the same beam as the beam used for SSB, CSI-RS, or SRS per SRS resource. Further, SRS-SpatialRelation Info may be configured or not configured in each SRS resource.
If the SRS-SpatialRelationInfo is configured in the SRS resource, the same beam as the beam used for SSB, CSI-RS or SRS is applied for transmission. However, if the SRS-SpatialRelation Info is not configured in the SRS resource, the UE randomly determines the Tx beam and transmits the SRS via the determined Tx beam in S930.

More specifically, for P-SRS with ‘SRS-ResourceConfigType’ set to ‘periodic’:

i) if SRS-SpatialRelationInfo is set to ‘SSB/PBCH,’ the UE transmits the corresponding SRS resource with the same spatial domain transmission filter (or generated from the corresponding filter) as the spatial domain Rx filter used for the reception of the SSB/PBCH; or

ii) if SRS-SpatialRelationInfo is set to ‘CSI-RS,’ the UE transmits the SRS resource with the same spatial domain transmission filter used for the reception of the periodic CSI-RS or SP CSI-RS; or

iii) if SRS-SpatialRelationInfo is set to ‘SRS,’ the UE transmits the SRS resource with the same spatial domain transmission filter used for the transmission of the periodic SRS.

Even if ‘SRS-ResourceConfigType’ is set to ‘SP-SRS’ or ‘AP-SRS,’ the beam determination and transmission operations may be applied similar to the above.
Additionally, the UE may receive or may not receive feedback for the SRS from the base station, as in the following three cases in S940.

i) If Spatial_Relation_Info is configured for all the SRS resources within the SRS resource set, the UE transmits the SRS with the beam indicated by the base station. For example, if the Spatial_Relation_Info indicates all the same SSB, CRI, or SRI, the UE repeatedly transmits the SRS with the same beam. This case corresponds to (a) of FIG. 8 as the usage for the base station to select the Rx beam.

ii) The Spatial_Relation_Info may not be configured for all the SRS resources within the SRS resource set. In this case, the UE may perform transmission while freely changing SRS beams. That is, this case corresponds to (b) of FIG. 8 as the usage for the UE to sweep the Tx beam.

iii) The Spatial_Relation_Info may be configured for only some SRS resources within the SRS resource set. In this case, the UE may transmit the configured SRS resources with the indicated beam, and transmit the SRS resources, for which Spatial_Relation_Info is not configured, by randomly applying the Tx beam.

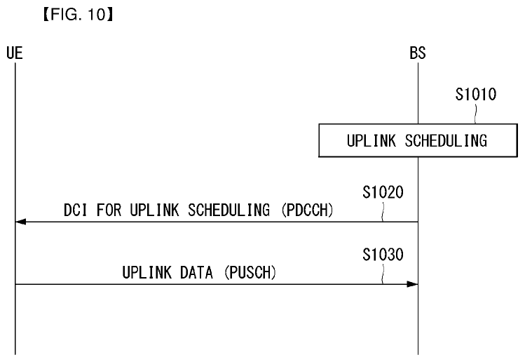

FIG. 10 is a flowchart showing an example of an uplink transmission/reception operation to which a method proposed in the present disclosure may be applied.

Referring to FIG. 10, the eNB schedules uplink transmission such as the frequency/time resource, the transport layer, an uplink precoder, the MCS, etc., (S1010). In particular, the eNB may determine a beam for PUSCH transmission of the UE through the aforementioned operations.

The UE receives DCI for downlink scheduling (i.e., including scheduling information of the PUSCH) on the PDCCH (S1020).

DCI format 0_0 or 0_1 may be used for the uplink scheduling and in particular, DCI format 0_1 includes the following information.

Identifier for DCI formats, UL/Supplementary uplink (SUL) indicator, Bandwidth part indicator, Frequency domain resource assignment, Time domain resource assignment, Frequency hopping flag, Modulation and coding scheme (MCS), SRS resource indicator (SRI), Precoding information and number of layers, Antenna port(s), SRS request, DMRS sequence initialization, and Uplink Shared Channel (UL-SCH) indicator.

In particular, configured SRS resources in an SRS resource set associated with higher layer parameter ‘usage’ may be indicated by an SRS resource indicator field. Further, ‘spatialRelationInfo’ may be configured for each SRS resource and a value of ‘spatialRelationInfo’ may be one of {CRI, SSB, and SRI}.

The UE transmits the uplink data to the eNB on the PUSCH (S1030).

When the UE detects a PDCCH including DCI format 0_0 or 0_1, the UE transmits the corresponding PUSCH according to the indication by the corresponding DCI.

Two transmission schemes, i.e., codebook based transmission and non-codebook based transmission are supported for PUSCH transmission:

i) When higher layer parameter txConfig′ is set to ‘codebook’, the UE is configured to the codebook based transmission. On the contrary, when higher layer parameter txConfig′ is set to ‘nonCodebook’, the UE is configured to the non-codebook based transmission. When higher layer parameter ‘txConfig’ is not configured, the UE does not predict that the PUSCH is scheduled by DCI format 0_1. When the PUSCH is scheduled by DCI format 0_0, the PUSCH transmission is based on a single antenna port.

In the case of the codebook based transmission, the PUSCH may be scheduled by DCI format 0_0, DCI format 0_1, or semi-statically. When the PUSCH is scheduled by DCI format 0_1, the UE determines a PUSCH transmission precoder based on the SRI, the Transmit Precoding Matrix Indicator (TPMI), and the transmission rank from the DCI as given by the SRS resource indicator and the Precoding information and number of layers field. The TPMI is used for indicating a precoder to be applied over the antenna port and when multiple SRS resources are configured, the TPMI corresponds to the SRS resource selected by the SRI. Alternatively, when the single SRS resource is configured, the TPMI is used for indicating the precoder to be applied over the antenna port and corresponds to the corresponding single SRS resource. A transmission precoder is selected from an uplink codebook having the same antenna port number as higher layer parameter ‘nrofSRS-Ports’.

When higher layer parameter ‘txConfig’ set to ‘codebook’ is configured for the UE, at least one SRS resource is configured in the UE. An SRI indicated in slot n is associated with most recent transmission of the SRS resource identified by the SRI and here, the SRS resource precedes PDCCH (i.e., slot n) carrying the SRI.

ii) In the case of the non-codebook based transmission, the PUSCH may be scheduled by DCI format 0_0, DCI format 0_1, or semi-statically. When multiple SRS resources are configured, the UE may determine the PUSCH precoder and the transmission rank based on a wideband SRI and here, the SRI is given by the SRS resource indicator in the DCI or given by higher layer parameter ‘srs-ResourceIndicator’. The UE may use one or multiple SRS resources for SRS transmission and here, the number of SRS resources may be configured for simultaneous transmission in the same RB based on the UE capability. Only one SRS port is configured for each SRS resource. Only one SRS resource may be configured to higher layer parameter ‘usage’ set to ‘nonCodebook’. The maximum number of SRS resources which may be configured for non-codebook based uplink transmission is 4. The SRI indicated in slot n is associated with most recent transmission of the SRS resource identified by the SRI and here, the SRS transmission precedes PDCCH (i.e., slot n) carrying the SRI.

Multi Panel Operation

Hereinafter, matters related to the definition of a panel in the present disclosure will be described in detail.

A “panel” referred to in the present disclosure may be based on at least one of the following definitions.

According to an embodiment, the “panel” may be interpreted/applied by being transformed into “one panel or a plurality of panels” or a “panel group”. The panel may be related to a specific characteristic (e.g., a timing advance (TA), a power control parameter, etc.). The plurality of panels may be panels having a similarity/common value in terms of the specific characteristic.

According to an embodiment, a “panel” may be interpreted/applied by being transformed into “one antenna port or a plurality of antenna ports”, “one uplink resource or a plurality of uplink resources”, an “antenna port group” or an “uplink resource group (or set)”. The antenna port or the uplink resource may be related to a specific characteristic (e.g., a timing advance (TA), a power control parameter, etc.). The plurality of antenna ports (uplink resources) may be antenna ports (uplink resources) having a similarity/common value in terms of the specific characteristic.

According to an embodiment, a “panel” may be interpreted/applied by being transformed into “one beam or a plurality of beams” or “at least one beam group (or set)”. The beam (beam group) may be related to a specific characteristic (e.g., a timing advance (TA), a power control parameter, etc.). The plurality of beams (beam groups) may be beams (beam groups) having a similarity/common value in terms of the specific characteristic.

According to an embodiment, a “panel” may be defined as a unit for a UE to configure a transmission/reception beam. For example, a “transmission panel (Tx panel)” may be defined as a unit in which a plurality of candidate transmission beams can be generated by one panel, but only one of the beams can be used for transmission at a specific time (that is, only one transmission beam (spatial relation information RS) can be used per Tx panel in order to transmit a specific uplink signal/channel).

According to an embodiment, a “panel” may refer to “a plurality antenna ports (or at least one antenna port)”, a “antenna port group” or an “uplink resource group (or set)” with common/similar uplink synchronization. Here, the “panel” may be interpreted/applied by being transformed into a generalized expression of “uplink synchronization unit (USU)”. Alternatively, the “panel” may be interpreted/applied by being transformed into a generalized expression of “uplink transmission entity (UTE)”.

Additionally, the “uplink resource (or resource group)” may be interpreted/applied by being transformed into a resource (or a resource group (set)) of a physical uplink shared channel (PUSCH)/physical uplink control channel (PUCCH)/sounding reference signal (SRS)/physical random access channel (PRACH). Conversely, a resource (resource group) of a PUSCH/PUCCH/SRS/PRACH may be interpreted/applied as an “uplink resource (or resource group)” based on the definition of the panel.

In the present disclosure, an “antenna (or antenna port)” may represent a physical or logical antenna (or antenna port).

As described above, a “panel” referred to in the present disclosure can be interpreted in various ways as “a group of UE antenna elements”, “a group of UE antenna ports”, “a group of logical antennas”, and the like. Which physical/logical antennas or antenna ports are mapped to one panel may be variously changed according to position/distance/correlation between antennas, an RF configuration and/or an antenna (port) virtualization method. The phaming process may vary according to a UE implementation method.

In addition, the “panel” referred to in the present disclosure may be interpreted/applied by being transformed into “a plurality of panels” or a “panel group” (having similarity in terms of specific characteristics).

Hereinafter, matters related to implementation of a multi-panel will be described.

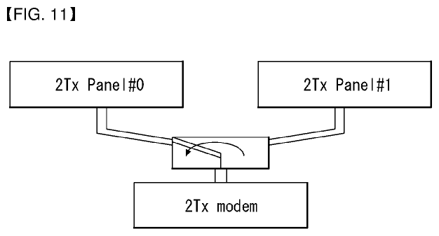

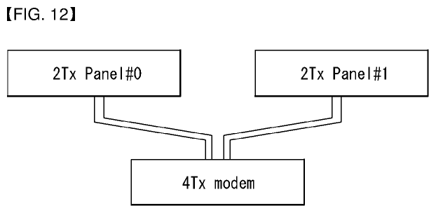

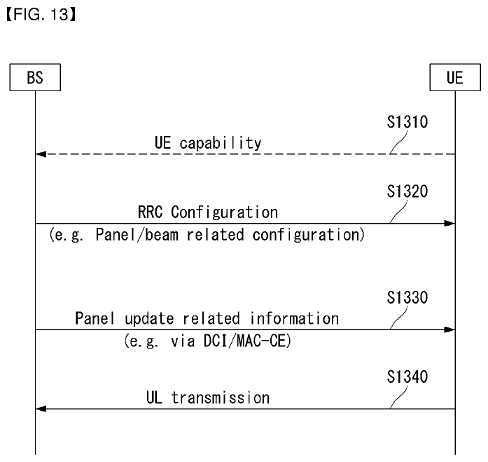

In the implementation of a UE in a high frequency band, modeling of a UE having a plurality of panels consisting of one or a plurality of antennas is being considered (e.g., bi-directional two panels in 3GPP UE antenna modeling). Various forms may be considered in implementing such a multi-panel. This is described below in detail with reference to FIGS. 11 and 12.

FIG. 11 and FIG. 12 illustrate an example of multi-panel based on an RF switch applied to the disclosure.

A plurality of panels may be implemented based on an RF switch.

Referring to FIG. 11, only one panel may be activated at a time, and signal transmission may be impossible for a predetermined time during which the activated panel is changed (i.e., panel switching).

FIG. 12 illustrates a plurality of panels according to different implementation schemes. Each panel may have an RF chain connected thereto so that it may be activated at any time. In this case, the time taken for panel switching may be zero or very short, and depending on the modem and power amplifier configuration, multiple panels may be simultaneously activated to transmit signals simultaneously (STxMP: simultaneous transmission across multi-panel).

In a UE having a plurality of panels described above, the radio channel state may be different for each panel, and the RF/antenna configuration may be different for each panel. Therefore, a method for estimating a channel for each panel is required. In particular, 1) to measure uplink quality or manage uplink beams or 2) to measure downlink quality for each panel or manage downlink beams using channel reciprocity, the following procedure is required.
A procedure for transmitting one or a plurality of SRS resources for each panel (here, the plurality of SRS resources may be SRS resources transmitted on different beams within one panel or SRS resources repeatedly transmitted on the same beam).

For convenience of description below, a set of SRS resources transmitted based on the same usage and the same time domain behavior in the same panel is referred to as an SRS resource group. The usage may include at least one of beam management, antenna switching, codebook-based PUSCH, or non-codebook based PUSCH. The time-domain behavior may be an operation based on any one of aperiodic, semi-persistent, and periodic.

The SRS resource group may use the configuration for the SRS resource set supported in the Rel-15 NR system, as it is, or separately from the SRS resource set, one or more SRS resources (based on the same usage and time-domain behavior) may be configured as the SRS resource group. In relation to the same usage and time-domain behavior, in the case of Rel-15, a plurality of SRS resource sets may be configured only when the corresponding usage is beam management. It is defined that simultaneous transmission is impossible between SRS resources configured in the same SRS resource set, but simultaneous transmission is possible between the SRS resources belonging to different SRS resource sets.

When considering the panel implementation scheme and multi-panel simultaneous transmission as shown in FIG. 12, the concept described above in connection with the SRS resource set may be directly applied to the SRS resource group. When considering panel switching according to the panel implementation scheme according to FIG. 11, an SRS resource group may be defined separately from the SRS resource set.

For example, a specific ID may be assigned to each SRS resource such that resources having the same ID belong to the same SRS resource group (SRS resource group) and resources having different IDs belong to different resource groups.

For example, when four SRS resource sets (e.g., RRC parameter usage is configured to ‘BeamManagement’) configured for a beam management (BM) usage are configured to the UE, each SRS resource set may be configured and/or defined to correspond to each panel of the UE. As an example, when four SRS resource sets are represented by SRS resource sets A, B, C, and D, and the UE implements a total of four (transmission) panels, each SRS resource set corresponds to one (transmission) panel to perform the SRS transmission.

As an example, implementation of the UE shown in Table 7 may be possible.

TABLE 7

| Maximum number of | Additional constraint |
|---|---|
| SRS resource sets | on the maximum of SRS |
| across all time | resource sets per supported |
| domain behavior | time domain behavior |
| (periodic/semi-persistent/aperiodic) | (periodic/semi-persistent/aperiodic) |
| 1 | 1 |
| 2 | 1 |
| 3 | 1 |
| 4 | 2 |
| 5 | 2 |
| 6 | 2 |
| 7 | 4 |
| 8 | 4 |

Referring to contents of Table 7, when the UE reports (or transmits), to the BS, UE capability information in which the number of SRS resource sets which may be supported by the UE itself is 7 or 8, the corresponding UE may be configured with up to a total of four SRS resource sets (for the BM usage) from the BS. In this case, as an example, the UE may also be defined, configured, and/or indicated to perform uplink transmission by making each of the SRS resource sets (for the BM usage) correspond to each panel (transmission panel and/or reception panel) of the UE. That is, an SRS resource set(s) for a specific usage (e.g., BM usage) configured to the UE may be defined, configured, and/or indicated to correspond to the panel of the UE. As an example, when the BS (implicitly or explicitly) configures and/or indicates, to the UE, a first SRS resource set in relation to the uplink transmission (configured for the BM usage), the corresponding UE may recognize to perform the uplink transmission by using a panel related (or corresponding) to the first SRS resource set.

Further, like the UE, when the UE that supports four panels transmits each panel to correspond to one SRS resource set for the BM usage, information on the number of SRS resources configurable per SRS resource set may also be include in the capability information of the UE. Here, the number of SRS resources may correspond to the number of transmittable beams (e.g., uplink beams) per panel of the UE. For example, the UE in which four panels are implemented may be configured to perform the uplink transmission in such a manner that two uplink beams correspond to two configured RS resources, respectively for each panel.

With respect to multi-panel transmission, UE category information may be defined in order for a UE to report performance information thereof related to multi-panel transmission. As an example, three multi-panel UE (MPUE) categories may be defined, and the MPUE categories may be classified according to whether a plurality of panels can be activated and/or whether transmission using a plurality of panels is possible.

In the case of the first MPUE category (MPUE category 1), in a UE in which multiple panels are implemented, only one panel may be activated at a time, and a delay for panel switching and/or activation may be set to [X]ms. For example, the delay may be set to be longer than a delay for beam switching/activation and may be set in units of symbols or slots.

In the case of the second MPUE category (MPUE category 2), in a UE in which multiple panels are implemented, multiple panels may be activated at a time, and one or more panels may be used for transmission. That is, simultaneous transmission using panels may be possible in the second MPUE category.

In the case of the third MPUE category (MPUE category 3), in a UE in which multiple panels are implemented, multiple panels may be activated at a time, but only one panel may be used for transmission.

With respect to multi-panel-based signal and/or channel transmission/reception proposed in the present disclosure, at least one of the three MPUE categories described above may be supported. For example, in Rel-16, MPUE category 3 among the following three MPUE categories may be (optionally) supported.

In addition, information on an MPUE category may be predefined on the standards or semi-statically configured according to a situation in a system (i.e., a network side or a UE side) and/or dynamically indicated. In this case, configuration/indication related to multi-panel-based signal and/or channel transmission/reception may be performed in consideration of the MPUE category.

Hereinafter, matters related to configuration/indication related to panel-specific transmission/reception will be described.

With respect to a multi-panel-based operation, transmission and reception of signals and/or channels may be panel-specifically performed. Here, “panel-specific” may mean that transmission and reception of signals and/or channels in units of panels can be performed. Panel-specific transmission/reception may also be referred to as panel-selective transmission/reception.

With respect to panel-specific transmission and reception in the multi-panel-based operation proposed in the present disclosure, a method of using identification information (e.g., an identifier (ID), an indicator, etc.) for setting and/or indicating a panel to be used for transmission and reception among one or more panels may be considered.

As an example, an ID for a panel may be used for panel selective transmission of a PUSCH, a PUCCH, an SRS, and/or a PRACH among a plurality of activated panels. The ID may be set/defined based on at least one of the following four methods (Alts 1, 2, 3, and 4).

Alt.1: ID for a panel may be an SRS resource set ID.

As an example, when the aspects according to a) to c) below are considered, it may be desirable that each UE Tx panel correspond to an SRS support set that is set in terms of UE implementation.

a) SRS resources of multiple SRS resource sets having the same time domain operation are simultaneously transmitted in the same bandwidth part (BWP).

b) Power control parameters are set in units of SRS resource sets.

c) A UE reports a maximum of 4 SRS resource sets (which may correspond to up to 4 panels) according to A supported time domain operation.

In the case of Alt.1 method, an SRS resource set related to each panel may be used for “codebook” and “non-codebook” based PUSCH transmission. In addition, a plurality of SRS resources belonging to a plurality of SRS resource sets may be selected by extending an SRI field of DCI. A mapping table between a sounding reference signal resource indicator (SRI) and an SRS resource may need to be extended to include the SRS resource in all SRS resource sets.

Alt.2: ID for a panel may be an ID (directly) associated with a reference RS resource and/or a reference RS resource set.

Alt.3: ID for a panel may be an ID directly associated with a target RS resource (reference RS resource) and/or a reference RS resource set.

In the case of Alt.3 method, configured SRS resource set(s) corresponding to one UE Tx panel can be controlled more easily, and the same panel identifier can be allocated to a plurality of SRS resource sets having different time domain operations.

Alt.4: ID for a panel may be an ID additionally set in spatial relation info (e.g., RRC parameter (SpatialRelationInfo)).

The Alt.4 method may be a method of newly adding information for indicating an ID for a panel. In this case, configured SRS resource set(s) corresponding to one UE Tx panel can be controlled more easily, and the same panel identifier can be allocated to a plurality of SRS resource sets having different time domain operations.

As an example, a method of introducing a UL TCI similarly to the existing DL TCI (Transmission Configuration Indication) may be considered. Specifically, UL TCI state definition may include a list of reference RS resources (e.g., SRS, CSI-RS and/or SSB). The current SRI field may be reused to select a UL TCI state from a configured set. Alternatively, a new DCI field (e.g., UL-TCI field) of DCI format 0_1 may be defined for the purpose of indicating the UL TCI state.

Information (e.g., panel ID, etc.) related to the above-described panel-specific transmission and reception can be transmitted through higher layer signaling (e.g., RRC message, MAC-CE, etc.) and/or lower layer signaling (e.g., L1 signaling, DCI, etc.). The information may be transmitted from a base station to a UE or from the UE to the base station according to circumstances or as necessary.

Further, the corresponding information may be set in a hierarchical manner in which a set for a candidate group is set and specific information is indicated.

Further, the above-described panel-related identification information may be set in units of a single panel or in units of multiple panels (e.g., a panel group or a panel set).

Hereinafter, contents related to panel/beam indication are described.

UL Transmission Configuration Indicator Framework (UL TCI Framework)

In Rel-15 NR, in order for a base station to indicate a transmission beam to be used when the base station transmits an UL channel to a UE, spatialRelationInfo may be used. The base station may configure/indicate, for the UE, a DL reference signal (e.g., an SSB-RI, a CRI (P/SP/AP) or an SRS (i.e., SRS resource) as a reference RS for a target UL channel and/or a target RS through an RRC configuration. Accordingly, the base station may indicate which UL transmission beam will be used when the corresponding UE transmits a PUCCH and an SRS. Furthermore, when the base station schedules a PUSCH for the UE, an SRS transmission beam indicated by the base station may be indicated as a transmission beam for PUSCH transmission through an SRI field, and the SRS transmission beam may be used as a PUSCH transmission beam of the UE.

Furthermore, an UL MIMO transmission scheme for PUSCH transmission in Rel-15 NR are two types, and codebook based (CB) UL transmission scheme and non-codebook based (NCB) UL transmission scheme may be considered.

Hereinafter, in this document, “the transmission of an SRS resource set” may be used as the same meaning as that “an SRS is transmitted based on information configured in an SRS resource set”, and “transmits an SRS resource” or “transmits SRS resources” may be used as the same meaning as that “transmits an SRS or SRSs based on information configured in an SRS resource.”

In the case of the CB UL transmission scheme, a base station first may configure and/or indicate, for a UE, an SRS resource set for a “CB” purpose (e.g., usage). The UE may transmit an SRS based on an n port SRS resource within the corresponding SRS resource set. The base station may obtain UL channel-related information based on the corresponding SRS transmission, and may use the UL channel-related information for the PUSCH scheduling of the UE.

Thereafter, the base station may perform the PUSCH scheduling through UL DCI, and may indicate the SRS resource for the “CB” purpose previously used for the SRS transmission of the UE through the SRI field of DCI. Accordingly, the base station may indicate a PUSCH transmission beam of the UE. Furthermore, the base station may indicate an uplink codebook through a TPMI field. Accordingly, the base station may indicate an UL rank and an UL precoder for the UE. The corresponding UE may perform PUSCH transmission as indicated by the base station.

In the case of the NCB UL transmission scheme, a base station may first configure and/or indicate, for a UE, an SRS resource set for a “non-CB” purpose (e.g., usage). The UE may determine a precoder to be applied to an SRS resources (a maximum of four resources, one port per resource) within the corresponding SRS resource set, based on the reception of an NZP CSI-RS linked to the corresponding SRS resource set. The corresponding UE may simultaneously transmit an SRS based on the corresponding SRS resources, based on the determined precoder. Thereafter, the base station may perform PUSCH scheduling through UL DCI, and may indicate some of SRS resources for the “non-CB” purpose previously used for the SRS transmission of the UE through the SRI field of DCI. Accordingly, the base station may indicate a PUSCH transmission beam of the UE. Furthermore, simultaneously, the base station may indicate an UL rank and an UL precoder through an SRI field. The corresponding UE may perform PUSCH transmission as indicated by the base station.

Regarding indication of a panel and/or a beam of UE in uplink transmission, a BS may configure/indicate panel-specific transmission for UL transmission for UL transmission through the following Alt.2 or Alt.3.
Alt.2: an UL-TCI framework is introduced, and UL-TCI-based signaling similar to DL beam indication supported in Rel-15 is supported.

A new panel ID may or may not be introduced.

A panel specific signaling is performed using UL-TCI state.
Alt.3: a new panel-ID is introduced. The corresponding panel-ID may be implicitly/explicitly applied to the transmission of a target RS resource/resource set, a PUCCH resource, an SRS resource or a PRACH resource.

A panel-specific signaling is performed implicitly (e.g., by DL beam reporting enhancement) or explicitly by using a new panel ID.

When signaling is explicitly performed, a panel-ID may be configured in a target RS/channel or a reference RS (e.g., DL RS resource configuration or spatial relation info).

For the panel ID, a new MAC CE may not be designated.

Table 8 below illustrates UL-TCI states based on the Alt.2.

TABLE 8

| Valid UL-TCI | Source | | |
|---|---|---|---|
| state | (reference) | (Target) | |
| Configuration | RS | UL RS | [qcl-Type] |
| 1 | SRS resource | DM-RS for PUCCH | Spatial- |
| | (for BM) + | or SRS or PRACH | relation |
| | [panel ID] | | |
| 2 | DL RS(a CSI-RS | DM-RS for PUCCH | Spatial- |
| | resource or a | or SRS or PRACH | relation |
| | SSB) + | | |
| | [panel ID] | | |
| 3 | DL RS(a CSI-RS | DM-RS for PUSCH | Spatial- |
| | resource or a | | relation + |
| | SSB) + | | [port(s)- |
| | [panel ID] | | indication] |
| 4 | DL RS(a CSI-RS | DM-RS for PUSCH | Spatial- |
| | resource or a SSB) | | relation + |
| | and SRS resource + | | [port(s)- |
| | [panel ID] | | indication] |
| 5 | SRS resource + | DM-RS for PUSCH | Spatial- |
| | [panel ID] | | relation + |
| | | | [port(s)- |
| | | | indication] |
| 6 | UL RS(a SRS for BM) | DM-RS for PUSCH | Spatial- |
| | and SRS resource + | | relation + |
| | [panel ID] | | [port(s)- |
| | | | indication] |

Furthermore, as in Table 8, an integrated framework for enabling a base station to configure and/or indicate a transmission panel/beam for an UL channel and/or UL RS of a UE may be considered. The framework may be denoted as an UL-TCI framework, for example, for convenience of description. The UL-TCI framework may have a form in which a DL-TCI framework considered in the existing technology (e.g., Rel-15 NR system) is extended in the UL. If the framework is based on the UL-TCI framework, a base station may configure, for a UE, a DL RS (e.g., an SSB-RI or a CRI) and/or an UL RS (e.g., an SRS) through higher layer signaling (e.g., a RRC configuration) as a reference RS or a source RS to be used/applied as a transmission beam for a target UL channel (e.g., a PUCCH, a PUSCH, a PRACH) and/or a target UL RS (e.g., an SRS). Upon transmission of the target UL channel and/or the target UL RS, the corresponding UE may use a transmission beam for a reference RS or source RS configured by the base station.

If the UL-TCI framework is applied, compared to the existing “SRI-based PUSCH scheduling and PUSCH beam indication” method in which an SRS for a “CB” or “non-CB” purpose must be transmitted before SRI indication for PUSCH transmission, there is an advantage in that overhead and delay can be reduced when a PUSCH transmission beam is configured and/or indicated. Furthermore, the UL-TCI framework-based method has an advantage in that it can be integrated and applied to all UL channels/RSs, such as a PUCCH/PUSCH/PRACH/SRS.

The above description (3GPP system, frame structure, NR system, etc.) can be applied in combination with methods proposed in the present disclosure which will be described later or supplemented to clarify the technical characteristics of the methods proposed in the present disclosure. The methods described below have been classified only for convenience of description, and some components of one method may be substituted with some components of another method or may be applied in combination therewith.

An UL MIMO transmission scheme for PUSCH transmission in Rel-15NR are two types, and includes codebook based (CB) UL and non-codebook based (NCB) UL. After NR Rel-16, in addition to multi-panel transmission of a UE transparent between the UE and a base station, the following operation may be considered. Specifically, in the state in which a multi-panel of the UE has been recognized by the base station and the UE, the base station may configure/indicate/schedule, for the UE, panel switching/selection-based transmission or a multi-panel simultaneous transmission across multi-panel (STxMP). The UE may perform the panel switching/selection-based transmission or the STxMP. Such a UE operation may be applied to the transmission of an UL control channel (e.g., a PUCCH) and an UL RS (e.g., an SRS or a PRACH) in addition to the UL data (e.g., PUSCH) transmission of a UE.

Hereinafter, the disclosure proposes an operation related to a method of controlling, by a base station, a transmission panel and/or beam of a UE for each specific UL channel/signal, and an UL transmission method of the UE thereof is described.

As illustrated in Table 8, in relation to panel and/or beam indication, i) a method of introducing an UL-TCI framework (i.e., Alt. 2) and ii) a method of introducing an identifier (e.g., panel ID) representing/indicating a panel (i.e., Alt. 3) may be considered.

Alt. 2 (UL-TCI) has an advantage in that a configurable parameter related to beam/panel management is simplified with respect to a UE implementation in addition to a network implementation. Accordingly, a UE can configure a common pool of the whole necessary reference information, and can use some of them (i.e., common pool) in specific UL transmission occasions.

Alt. 3 (Panel-ID) is proposed to explicitly introduce a new ID for a UE panel so that a base station can use a signaling method for controlling the use of a panel on the UE side. For example, a base station may indicate the transmission of a specific UL, such as a PUSCH, a PUCCH, an SRS and a PRACH, so that a UE performs the transmission of the specific UL by using another panel (not used by the UE so far). An advantage of the corresponding characteristic is that the consistent use of a specific UE panel which may not be the best in a base station-side UL interference condition or another available implementation option aspect can be avoided. The implementation option may be considered in a network implementation aspect (in particular, for an SRS) or may be considered for another UL beam pair link and in order to test quality thereof based on a command of a base station.

An UL TCI (Alt. 2) is a signaling framework capable of reducing signaling overhead for UL beam/panel management by integrating beam/panel configurations over various UL channels/signals. The introduction of the UL TCI framework may be advantageous for an overhead/latency reduction aspect, and may provide better extensibility for a future UL improvement (e.g., simultaneous transmission, STxMP over several panels). The reason for this is that to modify a RRC parameter separately configured for each UL channel/signal is easier than to update an UL TCI state. The most important thing is that Alt2 and Alt3 can be mutually supplemented without contradiction.

Accordingly, the disclosure proposes a method for applying/considering both (i.e., simultaneously) an UL-TCI (Alt. 2) and a Panel-ID (Alt. 3) as follows.

The following proposal(s) have been classified only for convenience of description, and some elements of a proposal may be substituted with an element of another proposal or they may be mutually combined and applied.

[Proposal 1]

A method of introducing both the UL-TCI (Alt. 2) and the Panel-ID (Alt. 3) may be considered. That is, an UL-TCI framework and a panel-ID may be configured so that they are applied to/used for panel and/or beam indication for the UL transmission of a UE.

[Proposal 1-1]

An UL-TCI state may be used for beam and panel management. The UL-TCI state may consist of the following information.

1) A spatial relation RS (e.g., a SSB resource, a CSI-RS resource, or a SRS resource)

2) A UE panel ID (a field when a corresponding UE is a multi-panel UE)

Table 9 below illustrates UL-TCI state configurations based on Proposal 1-1.

TABLE 9

| Valid UL-TCI | | Source | |
|---|---|---|---|
| state | P-ID | (reference) | |
| Configuration | (panel ID) | RS | [qcl-Type] |
| 1 | 1 | SRS resource | Spatial-relation |
| | | (for BM) | |
| 2 | 2 | DL RS(a CSI-RS | Spatial-relation |
| | | resource or a SSB) | |
| 3 | 1 | DL RS(a CSI-RS | Spatial-relation + |
| | | resource or a SSB) | [port(s)- |
| | | | indication) |
| 4 | 1 | DL RS(a CSI-RS | Spatial-relation + |
| | | resource or a SSB) | [port(s)- |
| | | and SRS resource | indication) |
| 5 | 2 | SRS resource | Spatial-relation + |
| | | | [port(s)- |
| | | | indication) |
| 6 | 2 | UL RS(a SRS for BM) | Spatial-relation + |
| | | and SRS resource | [port(s)- |
| | | | indication) |

Referring to Table 9, a panel ID (and spatial relation information, that is, beam-related information), that is, panel-related information, may be included in an UL-TCI state configuration for the transmission of an UL channel/signal of a UE.

[Proposal 1-2]

A pool of UL-TCI states may be configured through RRC. In this case, the UL-TCI states may be configured in a physical uplink control channel (PUCCH), a sounding reference signal (SRS), a physical uplink shared channel (PUSCH) and a physical random access channel (PRACH).

In this case, “A pool of UL-TCI states”, that is, a configuration for the UL-TCI states, may be defined so that it is configured as a (higher) RRC message prior to (or that needs to be prior to) a “PUCCH, SRS, PUSCH and/or PRACH”-related configuration. And/or the “pool of UL-TCI states” may be configured along with timing at which the “PUCCH, SRS, PUSCH and/or PRACH”-related configurations need to be provided. And/or a base station may configure “a pool of UL-TCI states” so that it is delivered/configured in a UE through/by using a specific (higher) RRC message (e.g., “initial RRC” and/or “cell-common RRC”) prior to common UE-dedicated RRC signaling. For example, the specific (higher) RRC message may include a m master information block (MIB).

[Method 1-1]

Hereinafter, a method related to the configuration/application/use of an UL TCI state related to PUCCH transmission is described below.

In the case of a PUCCH, an UL TCI state may be configured in each PUCCH resource instead of a PUCCH spatial relation.

In this case, a UE may transmit the PUCCH by using panel and/or beam information indicated by an indicated UL TCI state in relation to PUCCH transmission.

For example, the UE may transmit the PUCCH (to a base station) by applying a panel indicated by a panel ID included in (i.e., associated with) the indicated UL TCI state and/or a beam (e.g., a spatial Tx filter or a spatial Tx parameter) related to a spatial relation source RS.

In this case, the UE may apply/use/base the same (Tx) beam (e.g., a spatial Tx filter or a spatial Tx parameter) to the PUCCH transmission when the source RS is an SRS. That is, when the source RS is an SRS, the beam applied to the PUCCH transmission may be the same as a beam used to transmit the source RS (SRS).

Furthermore, when the source RS is a DL RS (e.g., a CSI-RS or an SSB), the UE may apply, to the PUCCH transmission, a (Tx) beam (e.g., a spatial Tx filter or a spatial Tx parameter) corresponding to (having correspondence or reciprocity with) an (Rx) beam (e.g., a spatial Rx filter or a spatial Rx parameter) in which the corresponding RS has been received. That is, when the source RS is a DL RS, the beam applied to the PUCCH transmission may be identical with or correspond to a beam used to receive the source RS (DL RS).

[Method 1-2]

Hereinafter, a method related to the configuration/application/use of an UL TCI state related to SRS transmission is described below.

In the case of an SRS, an UL TCI state may be configured in each SRS resource instead of an SRS spatial relation.

In this case, a UE may transmit an SRS by using panel and/or beam information indicated by an indicated UL TCI state in relation to SRS transmission.

For example, the UE may transmit the SRS (to a base station) by applying/using/based on a panel indicated by a panel-ID included in (i.e., associated with) the indicated UL-TCI state and/or a beam (e.g., a spatial Tx filter or a spatial Tx parameter) related to a source RS. In this case, when the source RS is an SRS, the UE may apply the same (Tx) beam (e.g., a spatial Tx filter or a spatial Tx parameter) to the SRS transmission. That is, when the source RS is an SRS, the beam applied to the SRS transmission may be the same as a beam used to transmit the source RS (SRS).

Furthermore, when the source RS is a DL RS (e.g., a CSI-RS or an SSB), the UE may apply, to the SRS transmission, a (Tx) beam (e.g., a spatial Tx filter or a spatial Tx parameter) corresponding to (having correspondence or reciprocity with) an (Rx) beam (e.g., a spatial Rx filter or a spatial Rx parameter) in which the corresponding RS has been received. That is, when the source RS is a DL RS, the beam applied to the SRS transmission may be identical with or correspond to a beam used to receive the source RS (DL RS).

[Method 1-3]

Hereinafter, a method related to the configuration/application/use of an UL TCI state related to PUSCH transmission is described below.

In the case of a PUSCH, a new UL-TCI field may be (optionally) configured in the DCI format 0_1 in addition to the existing SRI field.

In the DCI, code-points of the UL TCI field may refer to only an SRS as a spatial relation RS. For example, in order to apply only an SRS within a specific SRS resource set for a codebook-based UL or non-codebook-based UL usage as a reference, the following method may be considered. That is, restriction related to the code-points of the UL TCI field may be applied.

Hereinafter, the restriction related to the code points of the UL-TCI field is described.

If both an UL-TCI field and an SRI field are present in the DCI format 0_1, a default state of the UL-TCI field may be defined. The default state may be used as a flag indicating that the SRI field is valid. Specifically, if the code points of the UL-TCI field indicate a default state, a UE may use an SRI field by using the same method as the existing method. In this case, other states of the UL-TCI field indicate that the SRI field is not valid, and the UE needs to follow only an indicated UL-TCI state. That is, if the UL-TCI field is included in DCI, one specific code point (default code point) may be indication that offs an UL-TCI (indicating that the UL-TCI is not used). This is for coexistence with an operation of using the existing SRI field (considering backward compatibility).

For example, a case where an n-bit (e.g., n=3) UL-TCI field is defined/configured is assumed. In this case, the following situations (Case 1 and Case 2) may occur depending on the existing condition about whether the existing SRI field is present/included in a specific uplink-related DCI format (e.g., DCI format 0_1) (i.e., an UL DCI).

Case 1: in a situation in which a codebook (CB)-based UL or non-codebook (NCB)-based UL mode is configured (based on Tx-config, that is, an RRC parameter), when the number of SRS resources within an SRS resource set configured for the corresponding UL Tx mode is 1 (or less), the SRI field becomes 0 bit. Accordingly, the SRI field may not be included in the corresponding UL DCI.

In the case of Case 1, only the n-bit UL-TCI field is present in the corresponding UL DCI. In this case, a UE may be defined/configured/indicated to apply at least one of the following two options (Option 1 and Option 2):

Option 1

All 2\hat{ }n states (e.g., 2\hat{ }3=8 states when n=3) which may be dynamically indicated through the corresponding n-bit UL-TCI field may be configured as valid states.

A base station may link each of a total of 8 to a specific UL-TCI state to from “000” to “111” (through RRC/MAC CE signaling). Two or more UL-TCI states may be linked (e.g., for an STxMP purpose) to a state (i.e., any one of the 8 states) according to an UL-TCI field. A base station may dynamically select/indicate any one state (i.e., a code point of the UL TCI field) upon PUSCH scheduling through UL DCI among the pieces of linked information.

Option 2

One of 2\hat{ }n states (e.g., 2\hat{ }3=8 states when n=3) which may be dynamically indicated through a corresponding n-bit UL-TCI field may be configured as a “default state (e.g., “000”), and only the remaining {2\hat{ }n−1} states may be configured as valid states.

For example, (through RRC/MAC CE signaling) a base station may link each of a total of 7 states “001” to “111” to a specific UL-TCI state except a specific state (default state) (e.g., “000”). Two or more UL-TCI states may be linked to (e.g., for an STxMP purpose) a state (i.e., any one of the 7 states) according to the UL-TCI field. Thereafter, the base station may dynamically select/indicate a specific UL-TCI state(s) among the pieces of linked information/UL-TCI states through PUSCH scheduling DCI (UL DCI). A UE may apply an UL-TCI state(s) based on the UL DCI to PUSCH transmission.

Characteristically, when a “default state (e.g., “000”)” is dynamically indicated upon UL (data) scheduling, an operation that enables the default state to be “used as a flag to let a UE follow a single SRS resource as valid” may be defined/configured/indicated. That is, when the UL TCI field of UL DCI indicates the default state, the UE may operate by assuming that one SRS resource is valid. That is, in Case 1, if only one SRS resource has been configured in an SRS resource set, a base station may dynamically select/indicate a single SRS resource. The UE may perform a PUSCH precoder/port determination by using the corresponding SRS resource.

Case 2: in a situation in which the codebook (CB)-based UL or non-codebook (NCB)-based UL mode has been configured (based on Tx-config, that is, an RRC parameter), when the number of SRS resources within an SRS resource set configured for the corresponding UL Tx mode is two or more, an SRI field becomes 1 bit or more. Accordingly, the SRI field may be included along with corresponding UL DCI.

In the case of Case 2, the SRI field and an n-bit UL-TCI field are together present in the corresponding UL DCI. In this case, as in the proposal (e.g., Method 1-3), the following operation may be defined/configured/indicated to be applied.

When both the UL-TCI field and the SRI field are present in the DCI format 0_1, a default state of the UL-TCI field may be defined. The default state may be used as a flag indicating that the SRI field is valid. Specifically, when code points of the UL-TCI field indicate the default state, a UE may use the SRI field by using the same method as the existing method. In this case, other states of the UL-TCI field indicate that the SRI field is not valid, and the UE needs to follow only an indicated UL-TCI state.

One of 2\hat{ }n states (e.g., 2\hat{ }3=8 states when n=3) which may be dynamically indicated through a corresponding n-bit UL-TCI field may be configured as a “default state (e.g., “000”)”, and only the remaining {2\hat{ }n−1} states may be configured as valid states.

For example, (through RRC/MAC CE signaling) a base station may link each of a total of 7 states from “001” to “111” to a specific UL-TCI state except a specific state (default state) (e.g., “000”). Two or more UL-TCI states may be linked to a state (i.e., any one of the 7 states) according to a UL-TCI field (e.g., for an STxMP purpose). Thereafter, the base station may dynamically select/indicate a specific UL-TCI state(s) among the pieces of linked information/UL-TCI states through PUSCH scheduling DCI (UL DCI). The UE may apply the UL-TCI state(s) based on the UL DCI to PUSCH transmission.

Characteristically, when a “default state (e.g., “000”)” is dynamically indicated upon UL (data) scheduling, an operation that enables the default state to be “used as a flag to let a UE follow an SRI field as valid” may be defined/configured/indicated. That is, when the UL TCI field of the UL DCI indicates the default state, the UE may operate by assuming that the SRI field is valid. That is, a base station may dynamically select/indicate an SRI through the SRI field, and the UE may perform a PUSCH precoder/port determination based on the SRI.

[Method 1-4]

Hereinafter, a method related to the configuration/application/use of an UL TCI state related to PRACH transmission is described below.

In the case of a PRACH, an UL TCI state (including only a panel ID) may be configured for PDCCH-ordered PRACH transmission. In this case, embodiments described hereinafter may also be applied to other cases related to PRACH transmission.

For example, an UL TCI state related to PRACH transmission may be limited to an UL TCI state including only a panel ID. The reason for this is that when a corresponding PDCCH-order is indicated through a specific DCI (DCI format 1_0) that triggers the existing PDCCH-ordered PRACH, a specific SSB index may be indicated for a purpose to be applied to a (Tx) beam (e.g., a spatial Tx filter or a spatial Tx parameter).

That is, in order to prevent a collision between a corresponding SSB index (i.e., beam information) already indicated by the existing operation and additional configuration information (e.g., a spatial relation RS according to an UL-TCI state), when the UL TCI state is applied, space-related information (spatial relation info) among information (contents) of the corresponding UL TCI state may be limited to be not included.

In other words, an UL TCI state including only a panel ID may be configured/defined without spatial relation information (spatial relation info) for a PRACH transmission usage. Alternatively, although spatial relation information (spatial relation info) (to space-related information) is present in an UL-TCI state, as described above, upon (PDCCH-ordered) PRACH operation and/or non-contention-based random access (CFRA) PRACH operation, an operation that enables a UE to ignore the corresponding spatial relation information (spatial relation info) may be defined/configured/indicated.

Alternatively, upon (PDCCH-ordered) PRACH operation and/or non-contention-based random access (CFRA) PRACH operation, the UE may be configured to ignore other information except panel ID-related information among pieces of information related to an UL TCI state.

As another method, upon (PDCCH-ordered) PRACH operation and/or non-contention-based random access (CFRA) PRACH operation, indication by an UL-TCI state is not applied, but a method of indicating a panel ID in a way to add a new field to associated fields of the existing DCI may be considered. Specifically, when the existing PDCCH-order is indicated, in addition to associated fields (e.g., including an SSB index indicator, etc.) of specific DCI (DCI format 1_0), a new field such as a “panel-ID” field may be added. Upon PDCCH-order-related operation, since “reserved bits” are present in the corresponding DCI, a new field (e.g., a panel ID field) may be added by using the “reserved bits.” For example, reserved bits of 10 bits are present, and a base station/UE may reinterpret/use some bit(s) of the reserved bits as panel-ID indication for a purpose for applying a (Tx) beam (e.g., a spatial Tx filter or a spatial Tx parameter).

More characteristically, although a specific “Contention-Free Random Access (CFRA)” operation for another purpose occurs in addition to the case of a PDCCH-ordered PRACH, a UL-TCI state may be configured. A UE may transmit a PRACH by using panel and/or beam information indicated by an UL-TCI state indicated in relation to PRACH transmission in the CFRA process.

For example, a PRACH may be transmitted based on a panel indicated by a panel-ID included in an indicated UL-TCI state and/or a beam (e.g., a spatial Tx filter) related to source RS (source RS). In this case, the beam (e.g., a spatial Tx filter) for the PRACH transmission may be based on 1) the same spatial Tx filter when the source RS is an SRS, and 2) a spatial Tx filter corresponding to (having correspond or reciprocity with) a spatial R filter in which a corresponding DL RS has been received when the source RS is a DL RS (e.g., a CSI-RS or an SSB).

[Proposal 2]

If the aforementioned proposals (e.g., Proposals 1/1-1/1-2, Methods 1-1/1-2/1-3/1-4, etc.) are applied, a “default state (e.g., a “000” state)” may be dynamically indicated (e.g., DCI signaling) upon UL (data) scheduling.

In this case, an operation/configuration that enables dynamic indication for the “default state” to be used as 1) a flag that lets a UE to operate assuming that an SRI field is valid or 2) a flag that lets a UE to operate assuming that an SRS resource is valid may be considered.

In this case, there is no indication for a panel, and the following method may be considered. Specifically, an operation performed by a UE based on indicated SRS resource information may be defined/configured/indicated so that the operation is based on at least one of the followings 1) to 3).

1) A UE may apply beam (spatial Tx filter) information based on an indicated SRS resource. In this case, a Tx panel may be determined based on a UE implementation method.

2) A UE may apply beam (spatial Tx filter) information based on an indicated SRS resource. In this case, a Tx panel may be determined based on a flag. Specifically, a PUSCH may be transmitted by applying a Tx panel (and beam (spatial Tx filter)) used for the most recent transmission of i) an indicated SRS resource through a valid SRI field or ii) a valid single SRS resource without any change. That is, the UE may be defined/configured to perform the above operation.

3) A UE may apply beam (spatial Tx filter) information based on an indicated SRS resource. In this case, a Tx panel may be determined by a specific Tx panel (ID) (or a default Tx panel-ID, for example, a Panel-ID #0) predefined/configured to be applied when the flag is used (indicated).

And/or an operation of a UE to transmit SRS resources for all SRIs present in “the SRI field” (in association therewith) as “only a specific Tx panel (ID)” (or a default Tx panel-ID, for example, a Panel-ID #0) to be applied only when “the flag (i.e., default state) is received (indicated) may be defined/regulated/configured.

Such an operation has an effect in that it may act as a fallback operation in terms of a UE Tx panel. That is, by the aforementioned operation, an SRI field may be limited to an operation of performing transmission based on a default Tx panel. Accordingly, there is an advantage in that a fallback operation/scheduling that enables a default panel to operate as a kind of primary panel can be supported in a specific situation/environment in which panel selection is not smoothly supported.

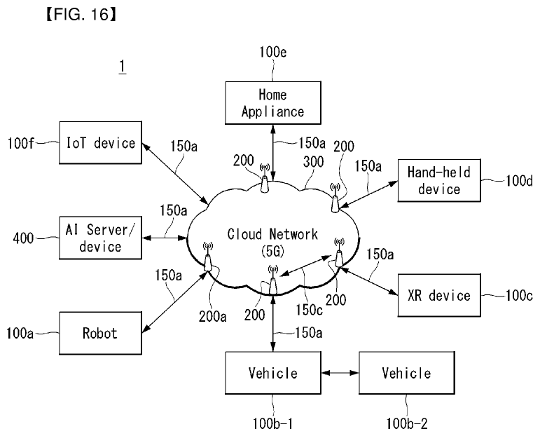

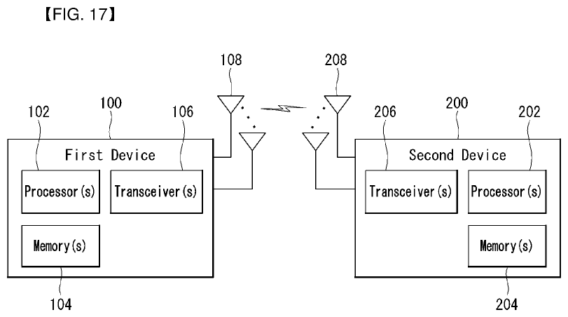

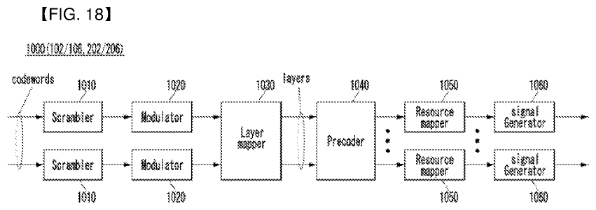

In an implementation aspect, operations (e.g., an operation related to the transmission of an uplink signal based on at least one of Proposals 1/1-1/1-2/Proposal 2, Methods 1-1/1-2/1-3/1-4) of a base station/UE according to the aforementioned embodiments may be processed by a device of FIGS. 16 to 20 (e.g., a processor 102, 202 in FIG. 17).

Furthermore, operations (e.g., an operation related to the transmission of an uplink signal based on at least one of Proposals 1/1-1/1-2/Proposal 2, Methods 1-1/1-2/1-3/1-4) of a base station/UE according to the aforementioned embodiment may be stored in a memory (e.g., 104, 204 in FIG. 17) in the form of a command/program (e.g., an instruction or an executable code) for driving at least one processor (e.g., 102, 202 in FIG. 17).

FIG. 13 illustrates an example of signaling between a UE/base station to which a method proposed in the disclosure may be applied. Specifically, FIG. 13 illustrates an example of signaling between a base station (BS) and a user equipment (UE) for performing UL transmission based on a panel/beam to which methods (e.g., Proposals 1/1-1/1-2/Proposal 2 and/or Methods 1-1/1-2/1-3/1-4) proposed in the disclosure may be applied.

In this case, the UE/BS are merely examples, and may be substituted/applied as various devices as will be described later with reference to FIGS. 16 to 20. FIG. 13 is merely for convenience of description and does not limit the scope of the disclosure. Referring to FIG. 13, a case where the UE supports one or more panels is assumed, and simultaneous transmission (i.e., a simultaneous transmission multi-panel) of an UL channel/RS using one or more panels may be supported. Furthermore, some step(s) illustrated in FIG. 13 may be omitted depending on a situation and/or configuration.

UE Operation

A UE may transmit UE capability information to a BS (S1310). The UE capability information may include UE capability information related to a panel. For example, the UE capability information may include the number of panels (groups) which may be supported by the UE, information about whether simultaneous transmission based on multiple panels can be performed, information for an MPUE category (MPUE category reference), etc. For example, the UE may transmit, to the BS, UE capability information related to the aforementioned proposal methods (e.g., Proposals 1/1-1/1-2/Proposal 2 and/or Methods 1-1/1-2/1-3/1-4).

For example, the operation of transmitting, by the UE (100/200 in FIGS. 16 to 20), the UE capability information to the BS (100/200 in FIGS. 16 to 20) in step S1310 may be implemented by a device in FIGS. 16 to 20 to be described hereinafter. For example, referring to FIG. 17, one or more processors 102 may control one or more transceivers 106 and/or one or more memories 104 to transmit the UE capability information. The one or more transceivers 106 may transmit the UE capability information to the BS.

The UE may receive, from the BS, RRC configuration information related to a panel and/or a beam (S1320). In this case, the RRC configuration information may include configuration information related to multi-panel-based transmission, configuration information related to UL (e.g., an SRS, a PUSCH, a PUCCH, or a PRACH, etc.) transmission, etc. Furthermore, the corresponding RRC configuration information may consist of one or multiple configurations, and may be delivered through UE-specific RRC signaling.

For example, the RRC configuration information may include the RRC configuration, etc. described in the aforementioned proposal methods (e.g., Proposals 1/1-1/1-2/Proposal 2 and/or Methods 1-1/1-2/1-3/1-4). For example, as in Proposals 1-1/1-2, the RRC configuration information may include configuration information (e.g., an UL TCI state configuration(s), a pool of UL TCI states) related to an UL TCI framework. For example, the configuration information related to the UL TCI framework may be composed by including/in association with panel-related information (e.g., a panel ID) and/or beam-related information (e.g., a spatial relation). For example, the configuration information related to the UL TCI framework may be configured as higher information than configuration information for UL transmission (e.g., an SRS, a PUSCH, a PUCCH, or a PRACH). Furthermore, the configuration information related to the UL TCI framework may be configured along with the configuration information for the UL transmission, or may be configured through separate signaling, etc. In this case, the configuration information related to the UL TCI framework may include one or more UL TCI states.

Furthermore, for example, as in Method 1-1, the one or more UL TCI states may be configured for each PUCCH resource. For example, as Method 1-2, the one or more UL TCI states may be configured with respect to each SRS resource. For example, as in Method 1-3, the one or more UL TCI states may include a default state related to PUSCH transmission. In this case, the corresponding RRC configuration information may include configuration information related to an operation according to a default state. For example, as in Method 1-4, the one or more UL TCI states may be configured for PDCCH-ordered PRACH transmission/CFRA procedure related-PRACH transmission, etc.

For example, the operation of receiving, by the UE (100/200 in FIGS. 16 to 20), the RRC configuration information from the BS (100/200 in FIGS. 16 to 20) in step S1320 may be implemented by the device in FIGS. 16 to 20 to be described hereinafter. For example, referring to FIG. 17, the one or more processors 102 may control the one or more transceivers 106 and/or the one or more memories 104 to receive the RRC configuration information. The one or more transceivers 106 may receive the RRC configuration information from the BS.

The UE may receive UL DCI that schedules UL transmission from the BS (S1330). In this case, the UL DCI may be for PUSCH transmission, aperiodic SRS transmission, etc. That is, in the case of some UL transmission, the corresponding step may be omitted.

For example, the UL DCI may include the indication information, etc. described in the aforementioned proposal methods (e.g., Proposals 1/1-1/1-2/Proposal 2 and/or Methods 1-1/1-2/1-3/1-4). For example, in relation to the SRS transmission in Method 1-2, the UL DCI may include information indicating a specific UL TCI state to be applied to aperiodic SRS transmission. For example, in relation to the PUSCH transmission in Method 1-3, the UL DCI may include an n-bit UL-TCI field and/or SRI field. In this case, as described in Method 1-3, an UL transmission operation of the UE may be classified depending on whether the n-bit UL-TCI field and/or SRI field is included in the UL DCI. Furthermore, for example, the UL DCI may include dynamic indication information for a default state (e.g., a “000” state) which may be considered in the aforementioned proposal methods (e.g., Proposals 1/1-1/1-2/Proposal 2 and/or Methods 1-1/1-2/1-3/1-4).

For example, the operation of receiving, by the UE (100/200 in FIGS. 16 to 20), the UL DCI from the BS (100/200 in FIGS. 16 to 20) in step S1330 may be implemented by the device in FIGS. 16 to 20 to be described hereinafter. For example, referring to FIG. 17, the one or more processors 102 may control the one or more transceivers 106 and/or the one or more memories 104 to receive the UL DCI. The one or more transceivers 106 may receive the UL DCI from the BS.

The UE may transmit (i.e., perform UL transmission) an UL channel/signal to the BS based on the RRC configuration information and/or the UL DCI (S1340). In this case, the UL channel/signal may include a PUCCH, an SRS, a PUSCH, a PRACH, etc. In the transmission of the PUCCH, the SRS, the PUSCH, or the PRACH, the aforementioned proposal methods (e.g., Proposals 1/1-1/1-2/Proposal 2 and/or Methods 1-1/1-2/1-3/1-4) may be applied.

For example, as in Method 1-1, the UE may transmit a PUCCH to the BS through/by using/based on a panel/beam by the corresponding UL TCI state based on a configured/indicated UL TCI state (in this case, the UL TCI state may be configured for each PUCCH resource). For example, as in Method 1-2, the UE may transmit an SRS to the BS through/by using/based on a panel/beam by the corresponding UL TCI state based on a configured/indicated UL TCI state (in this case, the UL TCI state may be configured with respect to each SRS resource). For example, as in Method 1-3, the UE may transmit a PUSCH to the BS through/by using/based on a panel/beam by an UL TCI state configured/indicated through the RRC configuration information and the UL DCI (e.g., a UL-TCI field), etc., based on the UL TCI state. For example, as in Method 1-4, the UE may transmit a PRACH (e.g., a PDCCH-ordered PRACH/CFRA procedure-related PRACH) to the BS through/by using/based on a panel/beam by a configured/indicated UL TCI state. For example, if a default state as in Proposal 2 is configured/indicated, the UE may be configured to perform UL transmission based on the operation(s) described in Proposal 2.

For example, the operation of performing, by the UE (100/200 in FIGS. 16 to 20), the UL transmission on the BS (100/200 in FIGS. 16 to 20) in step S1340 may be implemented by the device in FIGS. 16 to 20 to be described hereinafter. For example, referring to FIG. 17, the one or more processors 102 may control the one or more transceivers 106 and/or the one or more memories 104 to perform the UL transmission. The one or more transceivers 106 may perform the UL transmission on the BS.

BS Operation

ABS may receive UE capability information from a UE (S1310). The UE capability information may include the number of panels (groups) which may be supported by the UE, information about whether simultaneous transmission based on multiple panels can be performed, information for an MPUE category (MPUE category reference), etc. For example, the UE may transmit, to the BS, UE capability information related to the aforementioned proposal methods (e.g., Proposals 1/1-1/1-2/Proposal 2 and/or Methods 1-1/1-2/1-3/1-4).

For example, the operation of receiving, by the BS (100/200 in FIGS. 16 to 20), the UE capability information from the UE (100/200 in FIGS. 16 to 20) in step S1310 may be implemented by the device in FIGS. 16 to 20 to be described hereinafter. For example, referring to FIG. 17, the one or more processors 202 may control the one or more transceivers 206 and/or the one or more memories 204 to receive the UE capability information. The one or more transceivers 206 may receive the UE capability information from the UE.

The BS may transmit the RRC configuration information related to a panel and/or a beam to the UE (S1320). In this case, the RRC configuration information may include configuration information related to multi-panel-based transmission, configuration information related to UL (e.g., an SRS, a PUSCH, a PUCCH, or a PRACH, etc.) transmission, etc. Furthermore, the corresponding RRC configuration information may consist of one or multiple configurations, and may be delivered through UE-specific RRC signaling.

For example, the RRC configuration information may include the RRC configuration, etc. described in the aforementioned proposal methods (e.g., Proposals 1/1-1/1-2/Proposal 2 and/or Methods 1-1/1-2/1-3/1-4). For example, as in Proposals 1-1/1-2, the RRC configuration information may include configuration information (e.g., an UL TCI state configuration(s), a pool of UL TCI states) related to an UL TCI framework. For example, the configuration information related to the UL TCI framework may be composed by including/in association with panel-related information (e.g., a panel ID) and/or beam-related information (e.g., a spatial relation). For example, the configuration information related to the UL TCI framework may be configured as higher information than configuration information for UL transmission (e.g., an SRS, a PUSCH, a PUCCH, or a PRACH). Furthermore, the configuration information related to the UL TCI framework may be configured along with the configuration information for the UL transmission, or may be configured through separate signaling, etc. In this case, the configuration information related to the UL TCI framework may include one or more UL TCI states.

Furthermore, for example, as in Method 1-1, the one or more UL TCI states may be configured for each PUCCH resource. For example, as Method 1-2, the one or more UL TCI states may be configured with respect to each SRS resource. For example, as in Method 1-3, the one or more UL TCI states may include a default state related to PUSCH transmission. In this case, the corresponding RRC configuration information may include configuration information related to an operation according to a default state. For example, as in Method 1-4, the one or more UL TCI states may be configured for PDCCH-ordered PRACH transmission/CFRA procedure related-PRACH transmission, etc.

For example, the operation of transmitting, by the BS (100/200 in FIGS. 16 to 20), the RRC configuration information to the UE (100/200 in FIGS. 16 to 20) in step S1320 may be implemented by the device in FIGS. 16 to 20 to be described hereinafter. For example, referring to FIG. 17, the one or more processors 202 may control the one or more transceivers 206 and/or the one or more memories 204 to transmit the RRC configuration information. The one or more transceivers 206 may transmit the RRC configuration information to the UE.

The BS may transmit, to the UE, UL DCI that schedules UL transmission (S1330). In this case, the UL DCI may be for PUSCH transmission, aperiodic SRS transmission, etc. That is, in the case of some UL transmission, the corresponding step may be omitted.

For example, the UL DCI may include the indication information, etc. described in the aforementioned proposal methods (e.g., Proposals 1/1-1/1-2/Proposal 2 and/or Methods 1-1/1-2/1-3/1-4). For example, in relation to the SRS transmission in Method 1-2, the UL DCI may include information indicating a specific UL TCI state to be applied to aperiodic SRS transmission. For example, in relation to the PUSCH transmission in Method 1-3, the UL DCI may include an n-bit UL-TCI field and/or SRI field. In this case, as described in Method 1-3, an UL transmission operation of the UE may be classified depending on whether the n-bit UL-TCI field and/or SRI field is included in the UL DCI. Furthermore, for example, the UL DCI may include dynamic indication information for a default state (e.g., a “000” state) which may be considered in the aforementioned proposal methods (e.g., Proposals 1/1-1/1-2/Proposal 2 and/or Methods 1-1/1-2/1-3/1-4).

For example, the operation of transmitting, by the BS (100/200 in FIGS. 16 to 20), the UL DCI to the UE (100/200 in FIGS. 16 to 20) in step S1330 may be implemented by the device in FIGS. 16 to 20 to be described hereinafter. For example, referring to FIG. 17, the one or more processors 202 may control the one or more transceivers 206 and/or the one or more memories 204 to transmit the UL DCI. The one or more transceivers 206 may transmit the UL DCI to the UE.

The BS may receive (i.e., receive UL transmission), from the UE, an UL channel/signal transmitted based on the RRC configuration information and/or UL DCI (S1340). In this case, the UL channel/signal may include a PUCCH, an SRS, a PUSCH, a PRACH, etc. In the transmission of the PUCCH, the SRS, the PUSCH, or the PRACH, the aforementioned proposal methods (e.g., Proposals 1/1-1/1-2/Proposal 2 and/or Methods 1-1/1-2/1-3/1-4) may be applied.

For example, as in Method 1-1, the BS may receive, from the UE, a PUCCH transmitted through/by using/based on a panel/beam by a corresponding UL TCI state based on a configured/indicated UL TCI state (in this case, the UL TCI state may be configured for each PUCCH resource). For example, as in Method 1-2, the BS may receive, from the UE, an SRS transmitted through/by using/based on a panel/beam by a corresponding UL TCI state based on a configured/indicated UL TCI state (in this case, the UL TCI state may be configured with respect to each SRS resource). For example, as in Method 1-3, the BS may receive, from the UE, a PUSCH transmitted through/by using/based on a panel/beam by an UL TCI state configured/indicated through the RRC configuration information and the UL DCI (e.g., the UL-TCI field, etc.), etc., based on the corresponding UL TCI state. For example, as in Method 1-4, in a CFRA procedure, the BS may receive, from the UE, a PRACH (e.g., a PDCCH-ordered PRACH/CFRA procedure-related PRACH) transmitted through/by using/based on a panel/beam by a configured/indicated UL TCI state. For example, if a default state as in Proposal 2 is configured/indicated, the BS may receive, from the UE, an UL channel/signaling performed based on the operation(s) described in Proposal 2.

For example, the operation of receiving, by the BS (100/200 in FIGS. 16 to 20), the UL channel/signal from the UE (100/200 in FIGS. 16 to 20) in step S1340 step may be implemented by the device in FIGS. 16 to 20 to be described hereinafter. For example, referring to FIG. 17, the one or more processors 202 may control the one or more transceivers 206 and/or the one or more memories 204 to receive the UL channel/signal. The one or more transceivers 206 may receive the UL channel/signal from the UE.

As described above, the aforementioned BS/UE signaling and operations (e.g., Proposals 1/1-1/1-2/Proposal 2 and/or Methods 1-1/1-2/1-3/1-4/FIG. 13) may be implemented by the device (e.g., FIGS. 16 to 20) to be described later. For example, the UE may correspond to a first device, and the BS may correspond to a second wireless device, and the opposite thereof may also be considered.

For example, the aforementioned BS/UE signaling and operations (e.g., Proposals 1/1-1/1-2/Proposal 2 and/or Methods 1-1/1-2/1-3/1-4/FIG. 13) may be processed by the one or more processors 102, 202 in FIG. 17. The aforementioned BS/UE signaling and operations (e.g., Proposals 1/1-1/1-2/Proposal 2 and/or Methods 1-1/1-2/1-3/1-4/FIG. 13) may be stored in a memory (e.g., the one or more memories 104, 204 in FIG. 17) in the form of a command/program (e.g., an instruction or an executable code) for driving at least one processor (e.g., 102, 202) in FIG. 17.

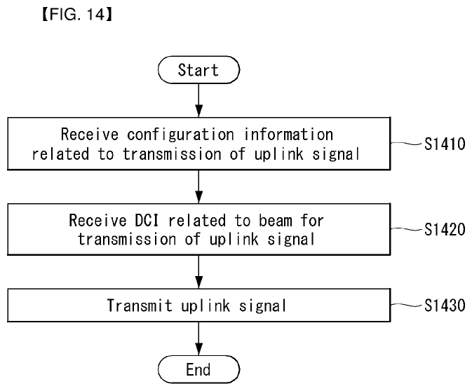

Hereinafter, the aforementioned embodiments are specifically described with reference to FIG. 14 from an operation aspect of a UE. Methods described hereinafter have been classified only for convenience of description, and some elements of a method may be substituted with an element of another method or they may be mutually combined and applied.

FIG. 14 is a flowchart for describing a method of transmitting, by a UE, an uplink signal in a wireless communication system according to an embodiment of the disclosure.

Referring to FIG. 14, the method of transmitting, by a UE, an uplink signal in a wireless communication system according to an embodiment of the disclosure may include a step S1410 of receiving configuration information related to the transmission of an uplink signal, a step S1420 of receiving downlink control information related to a beam for the transmission of the uplink signal, and a step S1430 of transmitting an uplink signal.

In S1410, the UE receives, from a base station, configuration information related to the transmission of an uplink signal. The configuration information may be based on an RRC message. The configuration information may include information for at least one of a panel or beam related to the transmission of the uplink signal.

According to an embodiment, the configuration information may be related to an uplink transmission configuration indicator state (UL TCI state). The UL TCI state may include a spatial relation RS related to a beam for the transmission of the uplink signal. The present embodiment may be based on Proposal 1.

According to an embodiment, the UL TCI state may include at least one panel ID related to the transmission of the uplink signal. The UL TCI state may be based on Proposal 1-1.

According to an embodiment, the configuration information may include information for a pool consisting of a plurality of UL TCI states. The present embodiment may be based on Proposal 1-2.

The operation of receiving, by the UE (100/200 in FIGS. 16 to 20), the configuration information related to the transmission of the uplink signal from the base station (100/200 in FIGS. 16 to 20) according to S1410 may be implemented by the device in FIGS. 16 to 20. For example, referring to FIG. 17, the one or more processors 102 may control the one or more transceivers 106 and/or the one or more memories 104 to receive the configuration information related to the transmission of the uplink signal from the base station 200.

In S1420, the UE receives, from the base station, downlink control information (DCI) related to a beam for the transmission of the uplink signal.

According to an embodiment, the DCI may include an UL TCI field related to the UL TCI state. The UL TCI field may be based on at least one of Methods 1-1, 1-2, 1-3 or 1-4.

The operation of receiving, by the UE (100/200 in FIGS. 16 to 20), the downlink control information (DCI) related to the beam for the transmission of the uplink signal from the base station (100/200 in FIGS. 16 to 20) according to S1420 may be implemented by the device in FIGS. 16 to 20. For example, referring to FIG. 17, the one or more processors 102 may control the one or more transceivers 106 and/or the one or more memories 104 to receive, from the base station 200, the downlink control information (DCI) related to the beam for the transmission of the uplink signal.

In S1430, the UE transmits the uplink signal to the base station based on the DCI.

According to an embodiment, the beam for the transmission of the PUSCH may be determined based on an SRI field of the DCI based on the uplink signal being the PUSCH and the UL TCI field indicating a specific state. The present embodiment may be based on Method 1-3.

The specific state may be based on default state of Method 1-3. The specific state may be one of a plurality of states which may be represented by a code point of the UL TCI field. In this case, when the UL TCI field indicates a state other than the specific state, a corresponding UL TCI field may represent the UL TCI state.

Based on the uplink signal being the PUSCH and the UL TCI field indicating the UL TCI state, the beam for the transmission of the PUSCH may be determined based on a spatial relation RS of the UL TCI state. In this case, a code point of the UL TCI field may be configured to refer to only an SRS resource within a specific SRS resource set. As a detailed example, if a case where the UL TCI field is 3 bits is assumed. The code point of the UL TCI field representing the specific state may be 000. A spatial relation RS of the UL TCI state which is represented by the remaining code points 001 to 111 other than the specific state may be related to an SRS resource within the specific resource set. The usage of the specific SRS resource set may be based on a codebook based UL or a non-codebook based UL. If the SRI field is used for the transmission of the PUSCH, a panel related to the transmission of the PUSCH may be determined as follows.

According to an embodiment, at least one panel related to the transmission of the PUSCH may be determined as a panel related to the transmission of a sounding reference signal (SRS) based on the SRI field. The present embodiment may be based on 2) of Proposal 2.

According to an embodiment, at least one panel related to the transmission of the PUSCH may be determined as a preconfigured panel among a plurality of panels of the UE. The present embodiment may be based on 3) of Proposal 2. The present embodiment may be limited and applied to only a case where an SRS resource within the SRS resource set configured in the UE is on (i.e., the SRI field=0 bit).

As described above, the transmission of an uplink signal (e.g., a PUSCH) based on a default panel (e.g., a panel based on an SRI field or a preconfigured panel) may be indicated through a specific state (e.g., a default state) of the UL TCI field of the DCI. The reliability of the transmission of an uplink signal in a specific situation in which it is difficult to smoothly support panel selection (panel switching) can be guaranteed.

As a case where the UL TCI field indicates a specific state (e.g., a default state), when an SRS resource within an SRS resource set configured in a corresponding UE is one, the SRI field may not be included in the DCI (i.e., the SRI field=0 bit). In this case, a beam/panel for the transmission of the PUSCH may be determined as follows.

According to an embodiment, based on an SRS resource within an SRS resource set configured in the UE being one, a beam (and/or panel) for the transmission of the PUSCH may be determined based on beam information (and/or panel information) related to the most recent transmission of an SRS. The usage of the SRS resource set may be based on a codebook based UL or a non-codebook based UL. The present embodiment may be based on Method 1-3, Proposal 2. The beam information may include a spatial Tx filter.

The operation of transmitting, by the UE (100/200 in FIGS. 16 to 20), the uplink signal to the base station (100/200 in FIGS. 16 to 20) based on the DCI according to S1430 may be implemented by the device in FIGS. 16 to 20. For example, referring to FIG. 17, the one or more processors 102 may control the one or more transceivers 106 and/or the one or more memories 104 to transmit the uplink signal to the base station 200 based on the DCI.

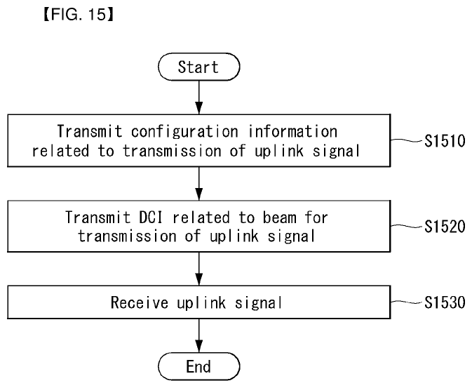

Hereinafter, the aforementioned embodiments are specifically described with reference to FIG. 15 from an operation aspect of a base station. Methods described hereinafter have been classified only for convenience of description, and some elements of a method may be substituted with an element of another method or they may be mutually combined and applied.

FIG. 15 is a flowchart for describing a method of receiving, by a base station, an uplink signal in a wireless communication system according to another embodiment of the disclosure.

Referring to FIG. 15, the method of receiving, by a base station, an uplink signal in a wireless communication system according to another embodiment of the disclosure may include a step S1510 of transmitting configuration information related to the transmission of an uplink signal, a step S1520 of transmitting downlink control information related to a beam for the transmission of the uplink signal, and a step S1530 of receiving the uplink signal.

In S1510, the base station transmits, to a UE, configuration information related to the transmission of an uplink signal. The configuration information may be based on an RRC message. The configuration information may include information for at least one of a panel or beam related to the transmission of the uplink signal.

According to an embodiment, the configuration information may be related to an uplink transmission configuration indicator state (UL TCI state). The UL TCI state may include a spatial relation RS related to a beam for the transmission of the uplink signal. The present embodiment may be based on Proposal 1.

According to an embodiment, the UL TCI state may include at least one panel ID related to the transmission of the uplink signal. The UL TCI state may be based on Proposal 1-1.

According to an embodiment, the configuration information may include information for a pool consisting of a plurality of UL TCI states. The present embodiment may be based on Proposal 1-2.

The operation of transmitting, by the base station (100/200 in FIGS. 16 to 20), the configuration information related to the transmission of the uplink signal to the UE (100/200 in FIGS. 16 to 20) according to S1510 may be implemented by the device in FIGS. 16 to 20. For example, referring to FIG. 17, the one or more processors 202 may control the one or more transceivers 206 and/or the one or more memories 204 to transmit, to the UE 100, the configuration information related to the transmission of the uplink signal.

In S1520, the base station transmits, to the UE, the downlink control information (DCI) related to the beam for the transmission of the uplink signal.

According to an embodiment, the DCI may include an UL TCI field related to the UL TCI state. The UL TCI field may be based on at least one of Methods 1-1, 1-2, 1-3 or 1-4.

The operation of transmitting, by the base station (100/200 in FIGS. 16 to 20), the downlink control information (DCI) related to the beam for the transmission of the uplink signal to the UE (100/200 in FIGS. 16 to 20) according to S1520 may be implemented by the device in FIGS. 16 to 20. For example, referring to FIG. 17, the one or more processors 202 may control the one or more transceivers 206 and/or the one or more memories 204 to transmit, to the UE 100, the downlink control information (DCI) related to the beam for the transmission of the uplink signal.

In S1530, the base station receives the uplink signal from the UE based on the DCI.

According to an embodiment, the beam for the transmission of the PUSCH may be determined based on an SRI field of the DCI based on the uplink signal being the PUSCH and the UL TCI field indicating a specific state. The present embodiment may be based on Method 1-3.

The specific state may be based on default state of Method 1-3. The specific state may be one of a plurality of states which may be represented by a code point of the UL TCI field. In this case, when the UL TCI field indicates a state other than the specific state, a corresponding UL TCI field may represent the UL TCI state.

Based on the uplink signal being the PUSCH and the UL TCI field indicating the UL TCI state, the beam for the transmission of the PUSCH may be determined based on a spatial relation RS of the UL TCI state. In this case, a code point of the UL TCI field may be configured to refer to only an SRS resource within a specific SRS resource set. As a detailed example, if a case where the UL TCI field is 3 bits is assumed. The code point of the UL TCI field representing the specific state may be 000. A spatial relation RS of the UL TCI state which is represented by the remaining code points 001 to 111 other than the specific state may be related to an SRS resource within the specific resource set. The usage of the specific SRS resource set may be based on a codebook based UL or a non-codebook based UL. If the SRI field is used for the transmission of the PUSCH, a panel related to the transmission of the PUSCH may be determined as follows.

If the SRI field is used for the reception of the PUSCH, a panel related to the transmission of the PUSCH may be determined as follows.

According to an embodiment, at least one panel related to the transmission of the PUSCH may be determined as a panel related to the transmission of a sounding reference signal (SRS) based on the SRI field. The present embodiment may be based on 2) of Proposal 2.

According to an embodiment, at least one panel related to the transmission of the PUSCH may be determined as a preconfigured panel among a plurality of panels of the base station. The present embodiment may be based on 3) of Proposal 2. The present embodiment may be limited and applied to only a case where an SRS resource within the SRS resource set configured in the UE is on (i.e., the SRI field=0 bit).

As described above, the transmission of an uplink signal (e.g., a PUSCH) based on a default panel (e.g., a panel based on an SRI field or a preconfigured panel) may be indicated through a specific state (e.g., a default state) of the UL TCI field of the DCI. The reliability of the transmission of an uplink signal in a specific situation in which it is difficult to smoothly support panel selection (panel switching) can be guaranteed.

As a case where the UL TCI field indicates a specific state (e.g., a default state), when an SRS resource within an SRS resource set configured in a corresponding UE is one, the SRI field may not be included in the DCI (i.e., the SRI field=0 bit). In this case, a beam/panel for the transmission of the PUSCH may be determined as follows.

According to an embodiment, based on an SRS resource within an SRS resource set configured in the UE being one, a beam (and/or panel) for the transmission of the PUSCH may be determined based on beam information (and/or panel information) related to the most recent transmission of an SRS. The usage of the SRS resource set may be based on a codebook based UL or a non-codebook based UL. The present embodiment may be based on Method 1-3, Proposal 2. The beam information may include a spatial Tx filter.

The operation of receiving, by the base station (100/200 in FIGS. 16 to 20), the uplink signal from the UE (100/200 in FIGS. 16 to 20) based on the DCI according to S1530 may be implemented by the device in FIGS. 16 to 20. For example, referring to FIG. 17, the one or more processors 202 may control the one or more transceivers 206 and/or the one or more memories 204 to receive the uplink signal from the UE 100 based on the DCI.

Example of Communication System Applied to Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 16 illustrates a communication system 1 applied to the present disclosure.

Referring to FIG. 16, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Example of Wireless Device Applied to the Present Disclosure

FIG. 17 illustrates wireless devices applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Example of Signal Processing Circuit Applied to the Present Disclosure

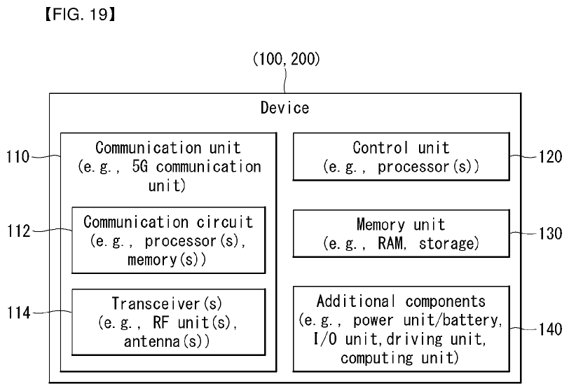

FIG. 18 illustrates a signal process circuit for a transmission signal.

Referring to FIG. 18, a signal processing circuit 1000 may include scramblers 1010, modulators 1020, a layer mapper 1030, a precoder 1040, resource mappers 1050, and signal generators 1060. An operation/function of FIG. 18 may be performed, without being limited to, the processors 102 and 202 and/or the transceivers 106 and 206 of FIG. 17. Hardware elements of FIG. 18 may be implemented by the processors 102 and 202 and/or the transceivers 106 and 206 of FIG. 17. For example, blocks 1010 to 1060 may be implemented by the processors 102 and 202 of FIG. 17. Alternatively, the blocks 1010 to 1050 may be implemented by the processors 102 and 202 of FIG. 17 and the block 1060 may be implemented by the transceivers 106 and 206 of FIG. 17.

Codewords may be converted into radio signals via the signal processing circuit 1000 of FIG. 18. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 18. For example, the wireless devices (e.g., 100 and 200 of FIG. 17) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Example of Application of Wireless Device Applied to the Present Disclosure

FIG. 19 illustrates another example of a wireless device applied to the present disclosure.

The wireless device may be implemented in various forms according to a use-case/service (refer to FIG. 16). Referring to FIG. 19, wireless devices 100 and 200 may correspond to the wireless devices 100 and 200 of FIG. 17 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 17. For example, the transceiver(s) 114 may include the one or more transceivers 106 and 206 and/or the one or more antennas 108 and 208 of FIG. 17. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcast terminal, a hologram device, a public safety device, an MTC device, a medicine device, a fintech device (or a finance device), a security device, a climate/environment device, the AI server/device (400 of FIG. 16), the BSs (200 of FIG. 16), a network node, etc. The wireless device may be used in a mobile or fixed place according to a use-example/service.

In FIG. 19, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Example of Hand-Held Device Applied to the Present Disclosure

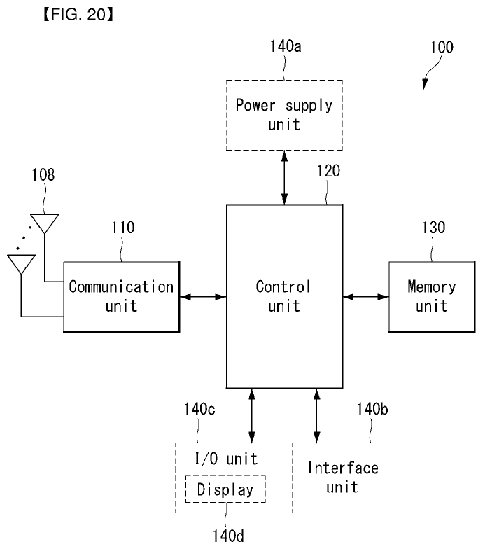

FIG. 20 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 20, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 19, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Hereinafter, effects of the method and device for transmitting and receiving uplink signals in a wireless communication system according to embodiments of the disclosure are described as follows.

According to an embodiment of the disclosure, a beam for the transmission of a PUSCH can be determined based on an SRI field of DCI based on an uplink signal being a physical uplink shared channel (PUSCH) and an UL TCI field of the DCI indicating a specific state.

Accordingly, although an uplink transmission configuration indicator state (UL TCI state) is configured for the transmission of an uplink signal, a beam for the transmission of a PUSCH can be determined without colliding against the existing beam indication operation.

According to an embodiment of the disclosure, at least one panel related to the transmission of the PUSCH can be determined as a panel related to the transmission of a sounding reference signal (SRS) based on the SRI field. Alternatively, at least one panel related to the transmission of the PUSCH can be determined as a preconfigured panel among a plurality of panels of a UE. That is, a panel based on the SRI field or a preconfigured panel is used for the transmission of the PUSCH based on an UL TCI field indicating a specific state (e.g., a default state). In a specific situation/environment in which panel selection (or panel switching) is not smoothly supported, the transmission of an uplink signal can be indicated based on a default panel (e.g., a panel based on an SRI field or a preconfigured panel) through (a specific state of) the UL TCI field.

In this case, a wireless communication technology implemented in a wireless device may include Narrowband Internet of Things for low power communication as well as LTE, NR and 6G implemented in a wireless device (e.g., 100/200 in FIG. 17) of the disclosure. In this case, for example, an NB-IoT technology may be an example of a low power wide area network (LPWAN) technology and may be implemented as standards, such as LTE Cat NB1 and/or LTE Cat NB2, and the disclosure is not limited to the aforementioned names. Additionally or alternatively, a wireless communication technology implemented in a wireless device (e.g., 100/200 in FIG. 17) of the disclosure may perform communication based on an LTE-M technology. In this case, for example, the LTE-M technology may be an example of the LPWAN technology, and may be called various names, such as enhanced machine type communication (eMTC). For example, the LTE-M technology may be implemented as at least any one of various standards, such as 1) LTE CAT 0, 2) LTE Cat M1, 3) LTE Cat M2, 4) LTE non-BL (non-Bandwidth Limited), 5) LTE-MTC, 6) LTE Machine Type Communication and/or 7) LTE M, etc., and the disclosure is not limited to the aforementioned names. Additionally or alternatively, a wireless communication technology implemented in a wireless device (e.g., 100/200 in FIG. 19) of the disclosure may include at least any one of ZigBee, Bluetooth and a low power wide area network (LPWAN) in which low power communication is considered, and the disclosure is not limited to the aforementioned names. For example, the ZigBee technology may generate personal area networks (PANs) related to small/low power digital communication based on various standards, such as IEEE 802. 15. 4, and may be called various names.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1-14. (canceled)

15. A method of transmitting, by a UE, an uplink signal in a wireless communication system, the method comprising:
receiving configuration information related to a transmission of an uplink signal;
receiving downlink control information (DCI) which includes a specific field related to the transmission of the uplink signal; and
transmitting the uplink signal based on the DCI,
wherein the configuration information is related to an uplink transmission configuration indicator state (UL TCI state), and the UL TCI state includes a spatial relation RS related to a beam for the transmission of the uplink signal,
wherein the specific field is related to the UL TCI state, and
wherein a beam for a transmission of a physical uplink shared channel (PUSCH) is determined based on an SRI field of the DCI, based on the uplink signal being the PUSCH and the specific field representing a pre-defined state.

16. The method of claim 15,
wherein the UL TCI state includes at least one panel ID related to the transmission of the uplink signal.

17. The method of claim 16,
wherein the at least one panel related to the transmission of the PUSCH is determined as a panel related to a transmission of a sounding reference signal (SRS) based on the SRI field.

18. The method of claim 16,
wherein the at least one panel related to the transmission of the PUSCH is determined as a preconfigured panel among a plurality of panels of the UE.

19. The method of claim 15,
wherein the beam for the transmission of the PUSCH is determined based on beam information related to a most recent transmission of the SRS, based on an SRS resource within an SRS resource set configured in the UE being one.

20. The method of claim 19,
wherein a usage of the SRS resource set is based on a codebook based UL or a non-codebook based UL.

21. The method of claim 15,
wherein the beam for the transmission of the PUSCH is determined based on the spatial relation RS of the UL TCI state, based on the uplink signal being the PUSCH and the specific field representing the UL TCI state.

22. The method of claim 21,
wherein the spatial relation RS is related to an SRS resource within a specific SRS resource set, and
wherein a usage of the specific SRS resource set is based on a codebook based UL or a non-codebook based UL.

23. The method of claim 15,
wherein the configuration information includes information for a pool consisting of a plurality of UL TCI states.

24. A UE transmitting an uplink signal in a wireless communication system, the UE comprising:
one or more transceivers;
one or more processors controlling the one or more transceivers; and
one or more memories capable of being operately connected to the one or more processors and storing instructions performing operations based on being executed by the one or more processors,
wherein the operations include:
receiving configuration information related to a transmission of an uplink signal;
receiving downlink control information (DCI) which includes a specific field related to the transmission of the uplink signal; and
transmitting the uplink signal based on the DCI,
wherein the configuration information is related to an uplink transmission configuration indicator state (UL TCI state), and the UL TCI state includes a spatial relation RS related to a beam for the transmission of the uplink signal,
wherein the specific field is related to the UL TCI state, and
wherein a beam for a transmission of a physical uplink shared channel (PUSCH) is determined based on an SRI field of the DCI, based on the uplink signal being the PUSCH and the specific field representing a pre-defined state.

25. A method of receiving, by a base station, an uplink signal in a wireless communication system, the method comprising:
transmitting configuration information related to a transmission of an uplink signal;
transmitting downlink control information (DCI) which includes a specific field related to the transmission of the uplink signal; and
receiving the uplink signal based on the DCI,
wherein the configuration information is related to an uplink transmission configuration indicator state (UL TCI state), and the UL TCI state includes a spatial relation RS related to a beam for the transmission of the uplink signal,
wherein the specific field is related to the UL TCI state, and
wherein a beam for a transmission of a physical uplink shared channel (PUSCH) is determined based on an SRI field of the DCI, based on the uplink signal being the PUSCH and the specific field representing a pre-defined state.
